(19) United States
(12) Patent Application Publication
(10) Pub. No.: US 2022/0294006 A1
(43) Pub. Date: Sep. 15, 2022

(54) SECONDARY BATTERY

(71) Applicant: MURATA MANUFACTURING CO., LTD., Kyoto (JP)

(72) Inventor: Kentaro YOSHIMURA, Kyoto (JP)

(21) Appl. No.: 17/825,603

(22) Filed: May 26, 2022

Related U.S. Application Data
(63) Continuation of application No. PCT/JP2020/041701, filed on Nov. 9, 2020.

(30) Foreign Application Priority Data
Nov. 27, 2019 (JP) 2019-214066

(51) Int. Cl. H01M 10/0525; H01M 4/485; H01M 10/056

(52) U.S. Cl. CPC H01M 10/0525; H01M 4/485; H01M 10/056; H01M 2004/027

(57) ABSTRACT

A secondary battery includes a positive electrode, a negative electrode, and an electrolyte. The negative electrode includes a hydroxycarboxylic acid compound. The hydroxycarboxylic acid compound includes a first hydroxycarboxylic acid compound, a second hydroxycarboxylic acid compound, or both. The electrolyte includes a high-dielectric-constant solvent having a dielectric constant of greater than or equal to 20 in a temperature range of higher than or equal to −30° C. and lower than 60° C. The high-dielectric-constant solvent includes a lactone. A content of the lactone in the high-dielectric-constant solvent is greater than or equal to 65 wt % and less than or equal to 100 wt %. At least one of the positive electrode, the negative electrode, or the electrolyte includes inorganic oxide particles.

### CROSS REFERENCE TO RELATED APPLICATIONS

The present application is a continuation of PCT patent application No. PCT/JP2020/041701, filed on Nov. 9, 2020, which claims priority to Japanese patent application no. JP2019-214066 filed on Nov. 27, 2019, the entire contents of which are being incorporated herein by reference.

### BACKGROUND

The present technology generally relates to a secondary battery that includes a positive electrode, a negative electrode, and an electrolyte.

Various kinds of electronic equipment, including mobile phones, have been widely used. Such widespread use has promoted development of a secondary battery as a power source that is smaller in size and lighter in weight and allows for a higher energy density. The secondary battery includes a positive electrode, a negative electrode, and an electrolyte. A configuration of the secondary battery influences a battery characteristic and has therefore been considered in various ways.

Specifically, in order to improve a cyclability characteristic, an electrolyte layer includes, together with an electrolytic solution, a copolymer including a perfluoro unsaturated compound. The electrolyte layer further includes inorganic particles each including a material such as aluminum oxide. The electrolytic solution includes a lactone such as γ-butyrolactone.

Further, in order to improve safety, a separator includes a porous substrate and a porous coating layer, and the porous coating layer includes inorganic particles each including a material such as zirconium oxide. In this case, a non-aqueous electrolyte includes a high-viscous non-aqueous solvent including a material such as γ-butyrolactone.

### SUMMARY

The present technology generally relates to a secondary battery that includes a positive electrode, a negative electrode, and an electrolyte.

Although consideration has been given in various ways to improve a battery characteristic of a secondary battery, the battery characteristic is not sufficient yet. Accordingly, there is still room for improvement in terms thereof.

The present technology has been made in view of such an issue and it is an object of the technology to provide a secondary battery that makes it possible to achieve a superior battery characteristic.

A secondary battery according to an embodiment of the present technology includes a positive electrode, a negative electrode, and an electrolyte. The negative electrode includes a hydroxycarboxylic acid compound. The hydroxycarboxylic acid compound includes a first hydroxycarboxylic acid compound represented by Formula (1), a second hydroxycarboxylic acid compound represented by Formula (2), or both. The electrolyte includes a high-dielectric-constant solvent having a dielectric constant of greater than or equal to 20 in a temperature range of higher than or equal to −30° C. and lower than 60° C. The high-dielectric-constant solvent includes a lactone. A content of the lactone in the high-dielectric-constant solvent is greater than or equal to 65 wt % and less than or equal to 100 wt %. At least one of the positive electrode, the negative electrode, or the electrolyte includes inorganic oxide particles. The inorganic oxide particles each include at least one of zirconium oxide, σ-type aluminum oxide, κ-type aluminum oxide, θ-type aluminum oxide, χ-type aluminum oxide, ρ-type aluminum oxide, η-type aluminum oxide, or γ-type aluminum oxide, and have a median diameter D50 of less than or equal to 1 μm.

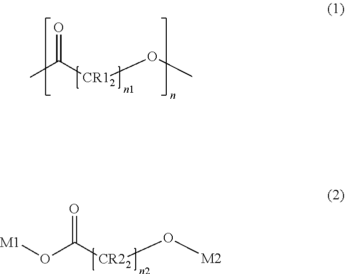

where:
each of R1 and R2 represents one of a hydrogen group, a halogen group, an alkyl group, or a halogenated alkyl group;
each of M1 and M2 represents one of hydrogen or an alkali metal element;
n is an integer of greater than or equal to 2; and
each of n1 and n2 is 2, 3, or 4.

A secondary battery according to another embodiment of the technology includes a positive electrode, a negative electrode, a separator, and an electrolyte. The negative electrode includes a hydroxycarboxylic acid compound. The hydroxycarboxylic acid compound includes a first hydroxycarboxylic acid compound represented by Formula (1), a second hydroxycarboxylic acid compound represented by Formula (2), or both. The separator is interposed between the positive electrode and the negative electrode. The electrolyte includes a high-dielectric-constant solvent having a dielectric constant of greater than or equal to 20 in a temperature range of higher than or equal to −30° C. and lower than 60° C. The high-dielectric-constant solvent includes a lactone. A content of the lactone in the high-dielectric-constant solvent is greater than or equal to 65 wt % and less than or equal to 100 wt %. The separator includes inorganic oxide particles. The inorganic oxide particles each include at least one of zirconium oxide, σ-type aluminum oxide, κ-type aluminum oxide, θ-type aluminum oxide, χ-type aluminum oxide, ρ-type aluminum oxide, η-type aluminum oxide, or γ-type aluminum oxide, and have a median diameter D50 of less than or equal to 1 μm.

According to the secondary battery of an embodiment of the present technology, the secondary battery includes the positive electrode, the negative electrode, and the electrolyte. The negative electrode includes the hydroxycarboxylic acid compound. The electrolyte includes the high-dielectric-constant solvent which includes the lactone whose content in the high-dielectric-constant solvent is within a predetermined range. At least one of the positive electrode, the negative electrode, or the electrolyte includes the inorganic oxide particles each including a material such as zirconium oxide and having a predetermined median diameter. Accordingly, it is possible to achieve a superior battery characteristic.

According to the secondary battery of an embodiment of the present technology, the secondary battery includes the positive electrode, the negative electrode, the separator, and the electrolyte. The negative electrode includes the hydroxycarboxylic acid compound. The electrolyte includes the high-dielectric-constant solvent which includes the lactone whose content in the high-dielectric-constant solvent is within a predetermined range. The separator includes the inorganic oxide particles each including a material such as zirconium oxide and having a predetermined median diameter. Accordingly, it is possible to achieve a superior battery characteristic.

It should be understood that effects of the technology are not necessarily limited to those described above and may include any of a series of effects described below in relation to the technology.

### BRIEF DESCRIPTION OF THE FIGURES

FIG. 1 is a perspective view of a configuration of a secondary battery of a laminated-film type according to an embodiment of the present technology.

FIG. 2 is a sectional view of a configuration of a wound electrode body illustrated in FIG. 1.

FIG. 3 is a sectional view of a configuration of another secondary battery of a cylindrical type according to an embodiment of the present technology.

FIG. 4 is a sectional view of a configuration of a wound electrode body included in a secondary battery according to an embodiment of the present technology.

FIG. 5 is a sectional view of a configuration of a wound electrode body included in a secondary battery according to an embodiment of the present technology.

FIG. 6 is a sectional view of a configuration of a wound electrode body included in a secondary battery according to an embodiment of the present technology.

FIG. 7 is a perspective view of a configuration of a stacked electrode body included in a secondary battery according to an embodiment of the present technology.

FIG. 8 is a sectional view of a configuration of the stacked electrode body illustrated in FIG. 7.

FIG. 9 is a block diagram illustrating a configuration of an application example of the secondary battery according to an embodiment, which is a battery pack including a single battery.

FIG. 10 is a block diagram illustrating a configuration of an application example of the secondary battery according to an embodiment, which is a battery pack including an assembled battery.

FIG. 11 is a block diagram illustrating a configuration of an application example of the secondary battery according to an embodiment, which is an electric vehicle.

### DETAILED DESCRIPTION

As described herein, the present disclosure will be described based on examples with reference to the drawings, but the present disclosure is not to be considered limited to the examples, and various numerical values and materials in the examples are considered by way of example.

A description is given first of a secondary battery according to an embodiment of the technology. The secondary battery to be described here is a secondary battery that obtains a battery capacity using insertion and extraction of an electrode reactant, and includes a positive electrode, a negative electrode, and an electrolyte.

In the secondary battery, to prevent precipitation of the electrode reactant on a surface of the negative electrode during charging, a charge capacity of the negative electrode is greater than a discharge capacity of the positive electrode. In other words, an electrochemical capacity per unit area of the negative electrode is set to be greater than an electrochemical capacity per unit area of the positive electrode.

Although not particularly limited in kind, the electrode reactant is a light metal such as an alkali metal or an alkaline earth metal. Examples of the alkali metal include lithium, sodium, and potassium. Examples of the alkaline earth metal include beryllium, magnesium, and calcium. Examples are given below of a case where the electrode reactant is lithium. A secondary battery that obtains a battery capacity using insertion and extraction of lithium is a so-called lithium-ion secondary battery. In the lithium-ion secondary battery, lithium is inserted and extracted in an ionic state.

A description is given first of a secondary battery of a laminated-film type. The secondary battery of the laminated-film type includes a film 20 that serves as an outer package member to contain a battery device. The film 20 has softness or flexibility.

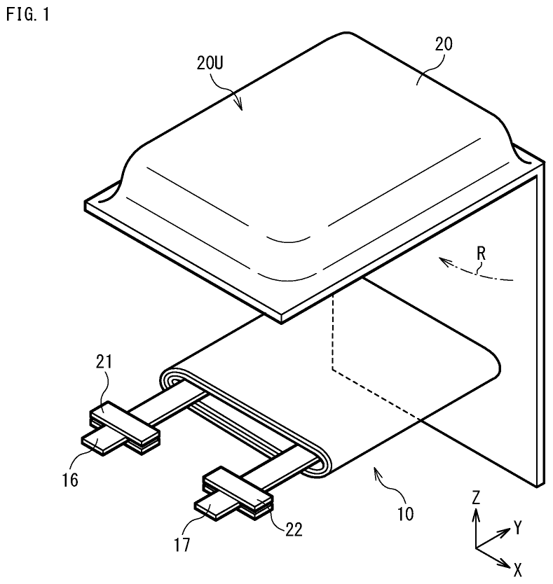

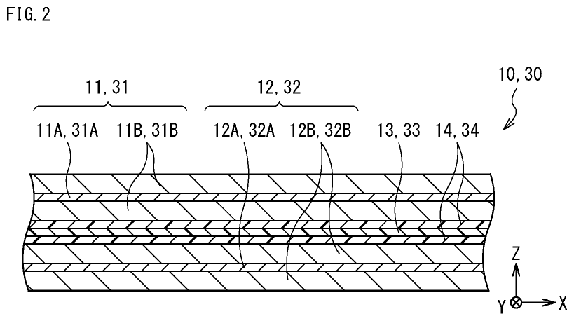

FIG. 1 illustrates a perspective configuration of the secondary battery of the laminated-film type. FIG. 2 illustrates a sectional configuration of a wound electrode body 10 illustrated in FIG. 1. It should be understood that FIG. 1 illustrates a state in which the wound electrode body 10 and the film 20 are separated away from each other, and FIG. 2 illustrates only a portion of the wound electrode body 10.

As illustrated in FIG. 1, in the secondary battery, a battery device of a wound type, i.e., the wound electrode body 10, is contained inside the film 20 having a pouch shape. To the wound electrode body 10, a positive electrode lead 16 and a negative electrode lead 17 are coupled. The positive electrode lead 16 and the negative electrode lead 17 are led out in respective directions that are similar to each other, from inside to outside the film 20.

The film 20 is a member having a shape of a single film that is foldable in a direction of an arrow R (an arrowed dash-dotted line) illustrated in FIG. 1. The film 20 has a depression part 20U to place the wound electrode body 10 therein. The depression part 20U is a so-called deep drawn part.

Specifically, the film 20 is a three-layered laminated film including a fusion-bonding layer, a metal layer, and a surface protective layer that are stacked in this order from an inner side. In a state in which the film 20 is folded, outer edges of the fusion-bonding layer are fusion-bonded to each other. The fusion-bonding layer includes a polymer compound such as polypropylene. The metal layer includes a metal material such as aluminum. The surface protective layer includes a polymer compound such as nylon. The number of layers of the film 20 as a laminated film is not limited to three, and may be one, two, or four or more.

A sealing film 21 is interposed between the film 20 and the positive electrode lead 16. A sealing film 22 is interposed between the film 20 and the negative electrode lead 17. Each of the sealing films 21 and 22 is a member that prevents entry of outside air, and includes one or more of materials having adherence to the positive electrode lead 16 and the negative electrode lead 17, such as a polyolefin resin. Examples of the polyolefin resin include polyethylene, polypropylene, modified polyethylene, and modified polypropylene. It should be understood that one or both of the sealing films 21 and 22 may be omitted.

As illustrated in FIGS. 1 and 2, the wound electrode body 10 includes a positive electrode 11, a negative electrode 12, a separator 13, an electrolyte, and inorganic oxide particles. Here, the electrolyte is, as will be described later, an electrolyte layer 14 which is a gel electrolyte. The wound electrode body 10 has a structure in which the positive electrode 11 and the negative electrode 12 are stacked on each other with the separator 13 and the electrolyte layer 14 interposed therebetween, and the stack of the positive electrode 11, the negative electrode 12, the separator 13, and the electrolyte layer 14 is wound. The electrolyte layer 14 includes an electrolytic solution which is a liquid electrolyte. The electrolyte layer 14 is interposed between the positive electrode 11 and the separator 13, and between the negative electrode 12 and the separator 13.

The inorganic oxide particles are included in any of a series of components other than the inorganic oxide particles that configures the wound electrode body 10. Details of each of components that includes the inorganic oxide particles are to be described later.

As illustrated in FIG. 2, the positive electrode 11 includes a positive electrode current collector 11A, and two positive electrode active material layers 11B provided on respective opposite sides of the positive electrode current collector 11A. However, the positive electrode active material layer 11B may be provided only on one of the opposite sides of the positive electrode current collector 11A.

The positive electrode current collector 11A includes one or more of electrically conductive materials including, without limitation, aluminum, nickel, and stainless steel.

The positive electrode active material layer 11B includes one or more of positive electrode active materials into which lithium is insertable and from which lithium is extractable. The positive electrode active material layer 11B may further include, without limitation, a positive electrode binder and a positive electrode conductor.

Although not particularly limited in kind, the positive electrode active material is a lithium-containing compound such as a lithium-containing transition metal compound. The lithium-containing transition metal compound includes lithium and one or more of transition metal elements, and may further include one or more of other elements. The other elements may be any elements other than transition metal elements, and are not particularly limited in kind. In particular, the other elements are preferably those belong to groups 2 to 15 in the long period periodic table of elements. It should be understood that the lithium-containing transition metal compound may be an oxide or may be any other compound such as a phosphoric acid compound, a silicic acid compound, or a boric acid compound.

Specific examples of the oxide include LiNiO₂, LiCoO₂, LiCo_{0.98}Al_{0.01}Mg_{0.01}O₂, LiNi_{0.5}Co_{0.2}Mn_{0.3}O₂, LiNi_{0.8}Co_{0.15}Al_{0.05}O₂, LiNi_{0.33}Co_{0.33}Mn_{0.3302}, Li_{1.2M}n_{0.52}Co_{0.175}Ni_{0.1}O₂, Li_{1.15}(Mn_{0.65}Ni_{0.22}Co_{0.13})O₂, and LiMn₂O₄. Specific examples of the phosphoric acid compound include LiFePO₄, LiMnPO₄, LiFe_{0.5}Mn_{0.5}PO₄, and LiFe_{0.3}Mn_{0.7}PO₄.

### (Positive Electrode Binder)

The positive electrode binder includes one or more of materials including, without limitation, a synthetic rubber and a polymer compound. Examples of the synthetic rubber include a styrene-butadiene-based rubber, a fluorine-based rubber, and ethylene propylene diene. Examples of the polymer compound include polyvinylidene difluoride, polyimide, and carboxymethyl cellulose.

The positive electrode conductor includes one or more of electrically conductive materials including, without limitation, a carbon material. Examples of the carbon material include graphite, carbon black, acetylene black, and Ketjen black. The positive electrode conductor may be a material such as a metal material or an electrically conductive polymer as long as the material has an electrically conductive property.

As illustrated in FIG. 2, the negative electrode 12 includes a negative electrode current collector 12A, and two negative electrode active material layers 12B provided on respective opposite sides of the negative electrode current collector 12A. However, the negative electrode active material layer 12B may be provided only on one of the opposite sides of the negative electrode current collector 12A.

The negative electrode current collector 12A includes one or more of electrically conductive materials including, without limitation, copper, aluminum, nickel, and stainless steel.

The negative electrode active material layer 12B includes one or more of hydroxycarboxylic acid compounds together with one or more of negative electrode active materials into which lithium is insertable and from which lithium is extractable. The hydroxycarboxylic acid compound includes a first hydroxycarboxylic acid compound represented by Formula (1), a second hydroxycarboxylic acid compound represented by Formula (2), or both. The negative electrode active material layer 12B may further include, without limitation, a negative electrode binder and a negative electrode conductor. Details of the negative electrode binder are similar to the details of the positive electrode binder, and details of the negative electrode conductor are similar to the details of the positive electrode conductor.

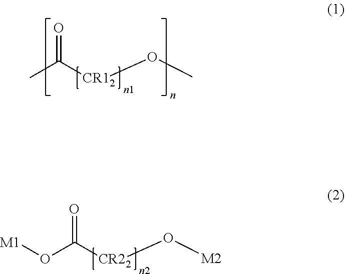

where:
each of R1 and R2 is one of a hydrogen group, a halogen group, an alkyl group, or a halogenated alkyl group;
each of M1 and M2 is one of hydrogen or an alkali metal element;
n is an integer of greater than or equal to 2; and
each of n1 and n2 is 2, 3, or 4.

A method of forming the negative electrode active material layer 12B is not particularly limited, and includes one or more of methods including, without limitation, a coating method, a vapor-phase method, a liquid-phase method, a thermal spraying method, and a firing (sintering) method.

The negative electrode active material is not particularly limited in kind, and examples thereof include a carbon material and a metal-based material. Examples of the carbon material include graphitizable carbon, non-graphitizable carbon, and graphite. The graphite may be natural graphite, artificial graphite, or both. The metal-based material is a material that includes, as a constituent element or constituent elements, one or more elements among metal elements and metalloid elements that are each able to form an alloy with lithium. Specifically, the metal-based material includes one or more of elements including, without limitation, silicon and tin as a constituent element or constituent elements. The metal-based material may be a simple substance, an alloy, a compound, or a mixture of two or more thereof.

Specific examples of the metal-based material that includes silicon, tin, or both as a constituent element or constituent elements include SiB₄, SiB₆, Mg₂Si, Ni₂Si, TiSi₂, MoSi₂, CoSi₂, NiSi₂, CaSi₂, CrSi₂, Cu₅Si, FeSi₂, MnSi₂, NbSi₂, TaSi₂, VSi₂, WSi₂, ZnSi₂, SiC, Si₃N₄, Si₂N₂O, SiOᵥ (0<v≤2 or 0.2<v<1.4), LiSiO, SnO_{w} (0<w≤2), SnSiO₃, LiSnO, and Mg₂Sn.

The hydroxycarboxylic acid compound may include only the first hydroxycarboxylic acid compound, only the second hydroxycarboxylic acid compound, or both.

A reason why the negative electrode 12 (the negative electrode active material layer 12B) includes the hydroxycarboxylic acid compound is that a stable film derived from the hydroxycarboxylic acid compound is formed in such a manner as to cover the negative electrode active material layer 12B (the negative electrode active material). This suppresses a decomposition reaction of the electrolytic solution on a surface of the negative electrode active material layer 12B. As a result, a decomposition reaction of a high-dielectric-constant solvent (a lactone) to be described later is suppressed upon charging and discharging.

As is apparent from Formula (1), the first hydroxycarboxylic acid compound is a polymer compound in which a repeating unit has a structure of a hydroxycarboxylic acid type. A value of n that determines the number of repetitions of the repeating unit is not particularly limited as long as the value is greater than or equal to 2, as described above. A content of the first hydroxycarboxylic acid compound in the negative electrode active material layer 12B is not particularly limited, and may thus be freely set.

A kind of R1 is not particularly limited as long as R1 is any one of a hydrogen group, a halogen group, an alkyl group, or a halogenated alkyl group, as described above. In other words, multiple R1's may be groups that are identical to each other, or may be groups that are different from each other. It goes without saying that only some of the multiple R1's may be groups that are identical to each other.

Although the halogen group is not particularly limited in kind, the halogen group includes, specifically, one of groups including, without limitation, a fluorine group, a chlorine group, a bromine group, and an iodine group. A reason for this is that a sufficiently stable film is easily formed.

Although the alkyl group is not particularly limited in kind, specific examples thereof include a methyl group, an ethyl group, a propyl group, a butyl group, a pentyl group, and a heptyl group. The alkyl group may have: a straight-chain structure; or a branched structure having one or more side chains. Although not particularly limited, carbon number of the alkyl group is preferably within a range from 1 to 5 both inclusive, in particular. A reason for this is that properties including, without limitation, solubility and compatibility of the first hydroxycarboxylic acid compound improve.

The halogenated alkyl group is a group obtained by substituting each of one or more hydrogen groups of an alkyl group with a halogen group, and details of the halogen group are as described above. In other words, the halogenated alkyl group includes one or more of the fluorine group, the chlorine group, the bromine group, or the iodine group. Details of the alkyl group are as described above. In other words, carbon number of the halogenated alkyl group is preferably within a range from 1 to 5 both inclusive for the above-described reason.

It should be understood that a value of n1 that determines the number of repetitions of a carbon chain moiety (—CR1₂-) is any one of 2, 3, or 4, as described above. Accordingly, the first hydroxycarboxylic acid compound includes four R1's at a minimum and eight R1's at a maximum.

As is apparent from Formula (2), the second hydroxycarboxylic acid compound is a monomer having a structure of a hydroxycarboxylic acid type. A content of the second hydroxycarboxylic acid compound in the negative electrode active material layer 12B is not particularly limited, and may thus be freely set.

Details of R2 (a halogen group, an alkyl group, a halogenated alkyl group, and carbon number) are similar to those of R1. In other words, multiple R2's may be groups that are identical to each other, or may be groups that are different from each other. It goes without saying that only some of the multiple R2's may be groups that are identical to each other.

It should be understood that a value of n2 that determines the number of repetitions of a carbon chain moiety (—CR2₂-) is any one of 2, 3, or 4. Accordingly, the second hydroxycarboxylic acid compound includes four R2's at a minimum and eight R2's at a maximum.

As described above, respective kinds of M1 and M2 are not particularly limited as long as each of M1 and M2 is one of a hydrogen or an alkali metal element. In other words, the respective kinds of M1 and M2 may be the same as each other, or may be different from each other.

Although the alkali metal element is not particularly limited in kind, the alkali metal element includes, specifically, one of lithium (Li), sodium (Na), or potassium (K). A reason for this is that a sufficiently stable film is easily formed.

### (Specific Examples of Hydroxycarboxylic Acid Compound)

Specific examples of the first hydroxycarboxylic acid compound include respective compounds represented by Formulae (1-1) to (1-10). Specific examples of the second hydroxycarboxylic acid compound include respective compounds represented by Formulae (2-1) to (2-12).

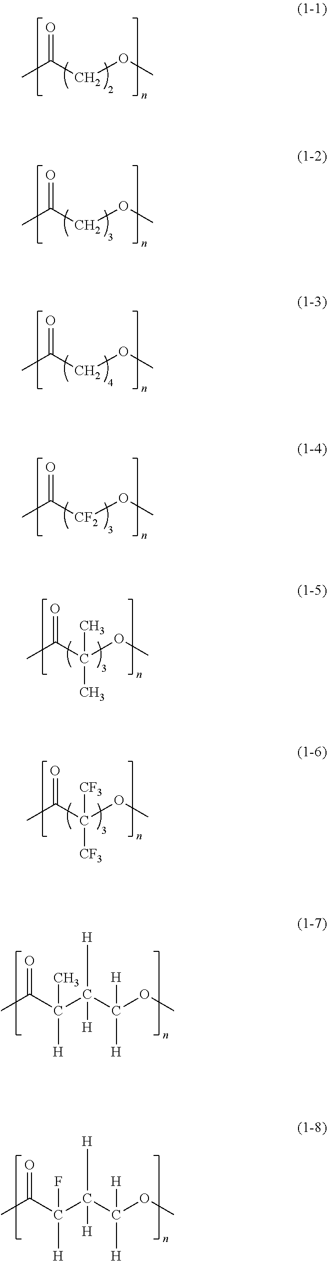

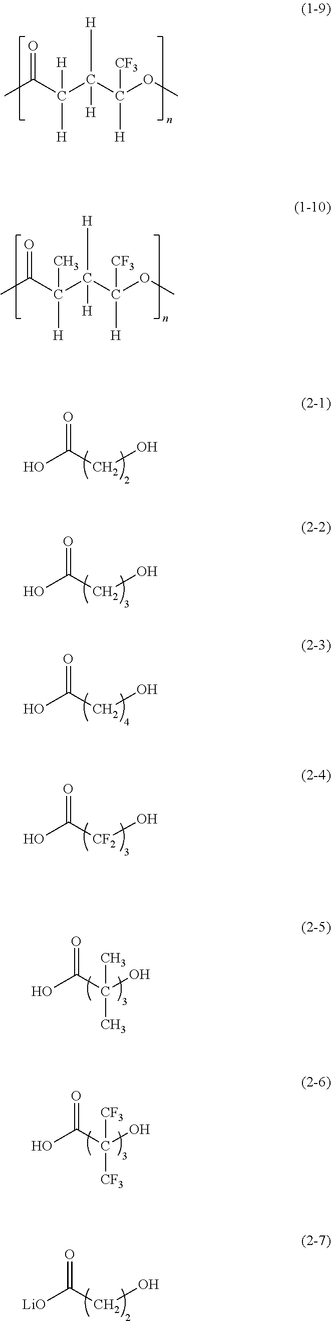

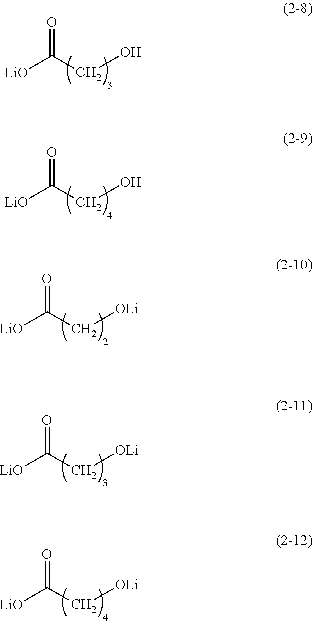

As illustrated in FIG. 2, the separator 13 is interposed between the positive electrode 11 and the negative electrode 12. The separator 13 is an insulating porous film that allows lithium to pass therethrough while preventing a short-circuit due to contact between the positive electrode 11 and the negative electrode 12. The separator 13 may be a single-layer film including one porous film, or may be a multi-layer film including one or more porous films that are stacked on each other. Here, the separator 13 which is a single-layer film, i.e., a single-layer type, is used. The porous film includes one or more of polymer compounds including, without limitation, polytetrafluoroethylene, polypropylene, and polyethylene.

The electrolyte layer 14 includes the electrolytic solution, and a polymer compound that holds the electrolytic solution. The electrolytic solution is thus held by the polymer compound in the electrolyte layer 14. Use of the electrolyte layer 14 enables achievement of high ionic conductivity (e.g., greater than or equal to 1 mS/cm at room temperature) as compared with a case where the electrolytic solution is used as it is, and prevents leakage of the electrolytic solution.

The electrolytic solution includes a solvent and an electrolyte salt. The electrolytic solution may include only one solvent or may include two or more solvents. The electrolytic solution may include only one electrolyte salt or may include two or more electrolyte salts.

The solvent includes a non-aqueous solvent (an organic solvent), and the electrolytic solution including the non-aqueous solvent is a so-called non-aqueous electrolytic solution. The solvent includes the high-dielectric-constant solvent. The high-dielectric-constant solvent described here is a solvent having a high specific dielectric constant ε, and more specifically, a solvent having a specific dielectric constant ε of greater than or equal to 20 in a temperature range of higher than or equal to −30° C. and lower than 60° C. The high-dielectric-constant solvent includes a lactone which is a cyclic carboxylic acid ester, and a content of the lactone in the high-dielectric-constant solvent is within a range from 65 wt % to 100 wt % both inclusive.

A reason why the solvent includes the high-dielectric-constant solvent (the lactone) is that a dissociation property of the electrolyte salt improves and mobility of lithium ions also improves. Further, a reason why the content of the lactone in the high-dielectric-constant solvent is within the above-described range is that the kind and the content of the high-dielectric-constant solvent are made appropriate, which further improves the dissociation property of the electrolyte salt and further improves the mobility of the lithium ions. In this case, in particular, the decomposition reaction of the high-dielectric-constant solvent (the lactone) is suppressed on the surface of the negative electrode 12 (the negative electrode active material layer 12B), as described above. The decomposition reaction of the lactone is thus stably and continuously suppressed even if the lactone which is highly reactive is used. As a result, the dissociation property of the electrolyte salt continuously improves and the mobility of the lithium ions also continuously improves even if charging and discharging are repeated.

Although the lactone is not particularly limited in kind, specifically, the lactone includes one or more of lactones including, without limitation, γ-butyrolactone, β-propiolactone, γ-crotonolactone, 4-hydroxy-2-methyl-2-butenoic acid γ-lactone, α-methyl-γ-butyrolactone, α-angelicalactone, 1,4-dioxane-2-one, 3-methyl-2(5H)-furanone, γ-valerolactone, and δ-valerolactone. A reason for this is that the dissociation property of the electrolyte salt sufficiently improves, and the mobility of the lithium ions also sufficiently improves.

As is apparent from the above-described content of the lactone in the high-dielectric-constant solvent, which is within a range from 65 wt % to 100 wt % both inclusive, the high-dielectric-constant solvent includes only the lactone, or may include one or more of other compounds (excluding the lactone) together with the lactone. The other compounds are not particularly limited in kind as long as the other compounds are each a material having a high specific dielectric constant ε (ε≥20) as in the case of the lactone, and specific examples thereof include a cyclic carbonic acid ester. Examples of the cyclic carbonic acid ester include ethylene carbonate and propylene carbonate.

It should be understood that the solvent may include one or more of low-viscosity solvents each having a viscosity of smaller than or equal to 1 mPa·s together with the above-described high-dielectric-constant solvent. The low-viscosity solvent is not particularly limited in kind, and specific examples thereof include a chain carbonic acid ester and a chain carboxylic acid ester. Examples of the chain carbonic acid ester include dimethyl carbonate, diethyl carbonate, and ethylmethyl carbonate. Examples of the chain carboxylic acid ester include ethyl acetate, ethyl propionate, propyl propionate, and ethyl trimethyl acetate.

Further, the solvent may further include one or more of additives. Examples of the additive include an unsaturated cyclic carbonic acid ester, a halogenated carbonic acid ester, a sulfonic acid ester, a sulfuric acid ester, a sulfurous acid ester, an acid anhydride, a phosphoric acid ester, a nitrile compound, and an isocyanate compound. A reason for this is that chemical stability of the electrolytic solution improves.

Specifically, examples of the unsaturated cyclic carbonic acid ester include 1,3-dioxol-2-one (VC), 4-vinyl-1,3-dioxolane-2-one, and 4-methylene-1,3-dioxolane-2-one.

Examples of the halogenated carbonic acid ester include 4-fluoro-1,3-dioxolane-2-one (FEC) and 4,5-difluoro-1,3-dioxolane-2-one.

Examples of the sulfonic acid ester include 1,2-oxathiolane-2,2-dioxide, 3-methyl-1,2-oxathiolane-2,2-dioxide, 1,2-oxathiane-2,2-dioxide, 5H-1,2-oxathiol-2,2-dioxide, and methanesulfonic acid propargyl ester.

Examples of the sulfuric acid ester include 1,3,2-dioxathiolane-2,2-dioxide, 1,3,2-dioxathion-2,2-dioxide, 4-methylsulfonyloxymethyl-2,2-dioxo-1,3,2-dioxathiolane, 4-ethylsulfonyloxymethyl-2,2-dioxo-1,3,2-dioxathiolane, bis((2,2-dioxo-1,3,2-dioxathiolane-4-yl)methyl)sulfate, 1,2:3,4-di-O-sulfanyl-meso-erythritol, 1,2:3,4-di-O-sulfanyl-D,L-threitol, 4-methylsulfonyloxymethyl-2,2-dioxo-1,3,2-dioxathiolane, 4-ethylsulfonyloxymethyl-2,2-dioxo-1,3,2-dioxathiolane, bis((2,2-dioxo-1,3,2-dioxathiolane-4-yl)methyl)sulfate, 1,2:3,4-di-O-sulfanyl-meso-erythritol, 4-methylsulfonyloxymethyl-2,2-dioxo-1,3,2-dioxathiolane, 4-ethylsulfonyloxymethyl-2,2-dioxo-1,3,2-dioxathiolane, and bis((2,2-dioxo-1,3,2-dioxathiolane-4-yl)methyl)sulfate.

Examples of the sulfurous acid ester include 1,3,2-dioxathiolane-2-oxide and 4-methyl-1,3,2-dioxathiolane-2-oxide.

Examples of the acid anhydride include a disulfonic acid anhydride, a dicarboxylic acid anhydride, and a sulfonic acid carboxylic acid anhydride. The acid anhydride may have a cyclic structure or a chain structure. It should be understood that the cyclic acid anhydride has higher reactivity than the chain acid anhydride, and thus further improves the chemical stability of the electrolytic solution. However, the chain acid anhydride also improves the chemical stability of the electrolytic solution. Accordingly, not only the cyclic acid anhydride but also the chain acid anhydride may be used.

Examples of the disulfonic acid anhydride include 1,2-ethanedisulfonic acid anhydride, 1,3-propanedisulfonic acid anhydride, and hexafluoro-1,3-propanedisulfonic acid anhydride. Examples of the dicarboxylic acid anhydride include succinic acid anhydride, glutaric acid anhydride, maleic acid anhydride, itaconic acid anhydride, and 1,4-dioxane-2,6-dione. Examples of the sulfonic acid carboxylic acid anhydride include 2-sulfobenzoic acid anhydride, 2,2-dioxooxathiolane-5-one, and 1,2-oxathiane-6-one-2,2-dioxide.

Examples of the phosphoric acid ester include triethyl phosphate. Examples of the nitrile compound include acetonitrile, octanenitrile, benzonitrile, phthalonitrile, succinonitrile, glutaronitrile, adiponitrile, cebaconitrile, 1,3,6-hexanetricarbonitrile, 3,3′-oxydipropionitrile, 3-butoxypropionitrile, ethylene glycol bispropionitrile ether, 1,2,2,3-tetracyanopropane, tetracyanoethylene, fumaronitrile, 7,7,8,8-tetracyanoquinodimethane, cyclopentanecarbonitrile, 1,3,5-cyclohexatricarbonitrile, and 1,3-bis(dicyanomethylidene)indane. Examples of the isocyanate compound include 1,6-hexamethylene diisocyanate.

In particular, it is preferable that the additive be the unsaturated cyclic carbonic acid ester, the halogenated carbonic acid ester, or both. A reason for this is that the chemical stability of the electrolytic solution improves, thus suppressing decomposition of the electrolytic solution upon charging and discharging.

Further, it is preferable that the additive be a compound including sulfur (S) as a constituent element and an acid anhydride. Specifically, the additive is preferably a sulfonic acid ester, a sulfuric acid ester, a sulfurous acid ester, a disulfonic acid anhydride, a dicarboxylic acid anhydride, and a sulfonic acid carboxylic acid anhydride. A reason for this is that the chemical stability of the electrolytic solution improves, thus suppressing the decomposition of the electrolytic solution upon charging and discharging.

Further, it is preferable that the additive be the nitrile compound. A reason for this is that the chemical stability of the electrolytic solution improves, thus suppressing the decomposition of the electrolytic solution upon charging and discharging.

The electrolyte salt includes one or more of light metal salts including, without limitation, a lithium salt. Examples of the lithium salt include lithium hexafluorophosphate (LiPF₆), lithium tetrafluoroborate (LiBF₄), lithium trifluoromethanesulfonate (LiCF₃SO₃), lithium bis(fluorosulfonyl)imide (LiN(FSO₂)₂), lithium bis(trifluoromethanesulfonyl)imide (LiN(CF₃SO₂)₂), lithium tris(trifluoromethanesulfonyl)methide (LiC(CF₃SO₂)₃), and lithium bis(oxalato)borate (LiB(C₂O₄)₂). Although not particularly limited, a content of the electrolyte salt is within a range from 0.3 mol/kg to 3.0 mol/kg both inclusive with respect to the solvent. A reason for this is that high ion conductivity is obtainable.

The inorganic oxide particles each include one or more of zirconium oxide (ZrO₂), σ-type aluminum oxide (σ-Al₂O₃), κ-type aluminum oxide (κ-Al₂O₃), θ-type aluminum oxide (θ-Al₂O₃), χ-type aluminum oxide (χ-Al₂O₃), ρ-type aluminum oxide (ρ-Al₂O₃), η-type aluminum oxide (η-Al₂O₃), or γ-type aluminum oxide (γ-Al₂O₃).

The series of symbols (σ, κ, θ, χ, ρ, η, and γ) that precedes the above-mentioned “aluminum oxide” represents crystal structures of aluminum oxide (so-called alumina). In other words, the series of aluminum oxides listed here is a series of aluminum oxides excluding α-type aluminum oxide (α-Al₂O₃) and β-type aluminum oxide (β-Al₂O₃), and has crystal structures other than an α-type crystal structure and a β-type crystal structure.

Reasons why the inorganic oxide particles each include one or more of materials including, without limitation, zirconium oxide, are as follows.

One reason is that the inorganic oxide particles dissipate heat generated inside the secondary battery. In particular, α-type aluminum oxide has a markedly high heat conductivity as compared with a heat conductivity of a material such as zirconium oxide. Thus, an inner temperature of the secondary battery is prevented from increasing easily upon charging and discharging, which suppresses the decomposition of the electrolytic solution.

Another reason is that, among respective products (decomposition products) decomposed in the positive electrode 11 and the negative electrode 12, a component eluted in the electrolyte layer 14 (the electrolytic solution) is adsorbed on surfaces of the inorganic oxide particles. This prevents a low-quality film, which is a factor for increasing electric resistance, from being formed easily on the surface of each of the positive electrode 11 and the negative electrode 12. As a result, electric resistance of the secondary battery is prevented from increasing easily.

It should be understood that an average particle size, specifically, a median diameter D50, of the inorganic oxide particles is less than or equal to 1 μm. A reason for this is that a specific surface area of the inorganic oxide particles increases, and thus, the decomposition product is easily adsorbed in the respective surfaces of the inorganic oxide particles. This prevents the inner temperature of the secondary battery from increasing easily while sufficiently suppressing the increase in the electric resistance of the secondary battery. As a result, the decomposition of the electrolytic solution is suppressed while securing the electric resistance of the secondary battery upon charging and discharging.

As described above, the inorganic oxide particles are included in any of the series of components that configures the wound electrode body 10. In other words, the inorganic oxide particles are included in one or more of the positive electrode 11, the negative electrode 12, the separator 13, or the electrolyte layer 14. Specifically, here, the electrolyte layer 14 includes the inorganic oxide particles. Accordingly, the inorganic oxide particles are dispersed in the electrolyte layer 14.

In this case, only the electrolyte layer 14 interposed between the positive electrode 11 and the separator 13 may include the inorganic oxide particles, only the electrolyte layer 14 interposed between the negative electrode 12 and the separator 13 may include the inorganic oxide particles, or both of the electrolyte layers 14 may include the inorganic oxide particles. Here, both of the electrolyte layers 14 include the inorganic oxide particles.

The positive electrode lead 16 is coupled to the positive electrode 11 (the positive electrode current collector 11A), and the negative electrode lead 17 is coupled to the negative electrode 12 (the negative electrode current collector 12A). The positive electrode lead 16 includes one or more of electrically conductive materials including, without limitation, aluminum, and the negative electrode lead 17 includes one or more of electrically conductive materials including, without limitation, copper, nickel, and stainless steel. The positive electrode lead 16 and the negative electrode lead 17 each have a shape such as a thin plate shape or a meshed shape.

The secondary battery operates as described below. Upon charging, lithium is extracted from the positive electrode 11, and the extracted lithium is inserted into the negative electrode 12 via the electrolyte layer 14. Upon discharging, lithium is extracted from the negative electrode 12, and the extracted lithium is inserted into the positive electrode 11 via the electrolyte layer 14.

In a case of manufacturing the secondary battery, the positive electrode 11, the negative electrode 12, and the electrolyte layer 14 are each fabricated, following which the secondary battery is assembled, according to a procedure to be described below.

First, the positive electrode active material is mixed with materials including, without limitation, the positive electrode binder and the positive electrode conductor on an as-needed basis to thereby obtain a positive electrode mixture. Thereafter, the positive electrode mixture is put into a solvent such as an organic solvent to thereby prepare a paste positive electrode mixture slurry. Lastly, the positive electrode mixture slurry is applied on opposite sides of the positive electrode current collector 11A to thereby form the positive electrode active material layers 11B. Thereafter, the positive electrode active material layers 11B may be compression-molded by means of a machine such as a roll pressing machine. In this case, the positive electrode active material layers 11B may be heated. The positive electrode active material layers 11B may be compression-molded multiple times. In this manner, the positive electrode active material layers 11B are formed on the respective opposite sides of the positive electrode current collector 11A. Thus, the positive electrode 11 is fabricated.

The negative electrode active material layers 12B are formed on respective opposite sides of the negative electrode current collector 12A by a procedure similar to the procedure for fabricating the positive electrode 11 described above. Specifically, the negative electrode active material and the hydroxycarboxylic acid compound are mixed with materials including, without limitation, the negative electrode binder and the negative electrode conductor on an as-needed basis to thereby obtain a negative electrode mixture. Thereafter, the negative electrode mixture is put into a solvent such as an organic solvent to thereby prepare a paste negative electrode mixture slurry. In this case, as described above, only the first hydroxycarboxylic acid compound may be used, only the second hydroxycarboxylic acid compound may be used, or both may be used. Thereafter, the negative electrode mixture slurry is applied on the opposite sides of the negative electrode current collector 12A to thereby form the negative electrode active material layers 12B. Thereafter, the negative electrode active material layers 12B may be compression-molded. In this manner, the negative electrode active material layers 12B are formed on the respective opposite sides of the negative electrode current collector 12A. Thus, the negative electrode 12 is fabricated.

First, the electrolyte salt is added to a solvent including the high-dielectric-constant solvent to thereby prepare the electrolytic solution. In this case, as described above, the high-dielectric-constant solvent includes the lactone, and the content of the lactone in the high-dielectric-constant solvent is set to be within a range from 65 wt % to 100 wt % both inclusive. Thereafter, the electrolytic solution, the polymer compound, and the inorganic oxide particles are mixed with an additional solvent for viscosity adjustment on an as-needed basis to thereby prepare an application solution. In this case, as described above, the inorganic oxide particles each include a material such as zirconium oxide, and are set to have a median diameter D50 of less than or equal to 1 μm. The additional solvent is not particularly limited in kind. Lastly, the application solution is applied on the surface of the positive electrode 11 (the positive electrode active material layer 11B) to thereby form the electrolyte layer 14, and the application solution is applied on the surface of the negative electrode 12 (the negative electrode active material layer 12B) to thereby form the electrolyte layer 14.

First, the positive electrode lead 16 is coupled to the positive electrode 11 (the positive electrode current collector 11A) by a method such as a welding method, and the negative electrode lead 17 is coupled to the negative electrode 12 (the negative electrode current collector 12A) by a method such as a welding method. Thereafter, the positive electrode 11 on which the electrolyte layer 14 is formed and the negative electrode 12 on which the electrolyte layer 14 is formed are stacked on each other with the separator 13 interposed therebetween, following which the stack of the positive electrode 11, the negative electrode 12, the separator 13, and the electrolyte layers 14 is wound to thereby fabricate the wound electrode body 10. Lastly, the wound electrode body 10 is placed inside the depression part 20U and the film 20 is folded, following which outer edges of three sides of the film 20 (the fusion-bonding layer) are bonded to each other by a method such as a thermal fusion bonding method. The wound electrode body 10 is thereby contained in the pouch-shaped film 20. In this case, the sealing film 21 is interposed between the film 20 and the positive electrode lead 16, and the sealing film 22 is interposed between the film 20 and the negative electrode lead 17. In this manner, the wound electrode body 10 is sealed in the film 20. As a result, the secondary battery of the laminated-film type is completed.

The secondary battery of the laminated-film type has the following configuration. The negative electrode 12 includes the hydroxycarboxylic acid compound. The electrolytic solution in the electrolyte layer 14 includes the high-dielectric-constant solvent (the lactone), and the content of the lactone in the high-dielectric-constant solvent is within a range from 65 wt % to 100 wt % both inclusive. The electrolyte layer 14 includes the inorganic oxide particles. The inorganic oxide particles each include a material such as zirconium oxide, and have a median diameter D50 of less than or equal to 1 μm.

In this case, as described above, the stable film derived from the hydroxycarboxylic acid compound is formed in such a manner as to cover the negative electrode active material layer 12B (the negative electrode active material). This suppresses the decomposition of the electrolytic solution (the lactone) on the surface of the negative electrode 12. This allows the lactone to be easily remained even if charging and discharging are repeated. As a result, the dissociation property of the electrolyte salt continuously improves and the mobility of the lithium ions also continuously improves.

In addition, the heat generated upon charging and discharging is dissipated by the inorganic oxide particles each having a small particle size. This prevents electric resistance of the electrolyte layer 14 from increasing easily, and also prevents the inner temperature of the secondary battery from increasing easily. As a result, the decomposition of the electrolytic solution is suppressed while securing the electric resistance of the secondary battery upon charging and discharging.

Further, the component eluted from the decomposition product is adsorbed on the surfaces of the inorganic oxide particles, which prevents the low-quality film from being formed easily on the surface of each of the positive electrode 11 and the negative electrode 12. As a result, the electric resistance of the secondary battery is prevented from increasing easily.

Accordingly, reduction in a discharge capacity is suppressed even if charging and discharging are repeated under a severe environment such as a high-temperature environment. It is thus possible to achieve a superior battery characteristic.

In particular, regarding a configuration of the hydroxycarboxylic acid compound, the halogen group may include a group such as a fluorine group, and the halogenated alkyl group may include, without limitation, the fluorine group. This causes the sufficiently stable film to be easily formed, which makes it possible to achieve higher effects.

Further, the alkyl group and the halogenated alkyl group may each have carbon number within a range from 1 to 5 both inclusive. This improves properties including, without limitation, solubility and compatibility of the hydroxycarboxylic acid compound, which makes it possible to achieve higher effects.

Further, the alkali metal element may include an element such as lithium. This allows the sufficiently stable film to be easily formed, which makes it possible to achieve higher effects.

Further, the lactone may include a lactone such as γ-butyrolactone. This sufficiently improves the dissociation property of the electrolyte salt, and also sufficiently improves the mobility of the lithium ions. Accordingly, it is possible to achieve higher effects.

Further, the electrolyte layer 14 may include the inorganic oxide particles. This allows the above-described heat dissipation property of the inorganic oxide particles to be stably exhibited in the wound electrode body 10 including the electrolyte layer 14, which makes it possible to achieve higher effects.

Further, the electrolytic solution in the electrolyte layer 14 may include, without limitation, the unsaturated cyclic carbonic acid ester. This suppresses the decomposition of the electrolytic solution upon charging and discharging, which makes it possible to achieve higher effects.

Further, the electrolyte layer 14 (the electrolytic solution) may include, without limitation, a sulfonic acid ester. This suppresses the decomposition of the electrolytic solution upon charging and discharging, which makes it possible to achieve higher effects.

Further, the electrolyte layer 14 (the electrolytic solution) may include the nitrile compound. This suppresses the decomposition of the electrolytic solution upon charging and discharging, which makes it possible to achieve higher effects.

Further, the secondary battery may include a lithium-ion secondary battery. This allows a sufficient battery capacity to be obtained stably by utilizing lithium insertion and extraction, which makes it possible to achieve higher effects.

Next, a description is given of a secondary battery of a cylindrical type. The secondary battery of the cylindrical type includes a battery can 41 that serves as an outer package member to contain a battery device. The battery can 41 has rigidity.

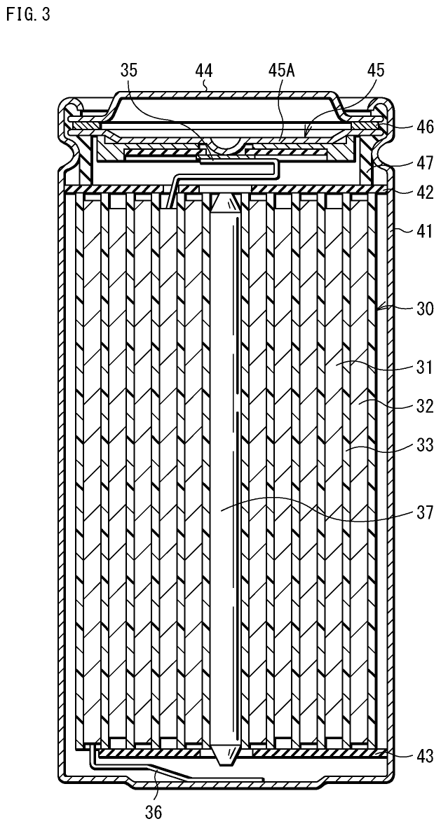

FIG. 3 illustrates a sectional configuration of the secondary battery of the cylindrical type. In the following description, reference will be made as necessary to the components of the secondary battery of the laminated-film type (FIG. 2), which have been already described above.

As illustrated in FIG. 3, in the secondary battery, a pair of insulating plates 42 and 43 and a battery device of a wound type, i.e., a wound electrode body 30, are contained inside the battery can 41 having a cylindrical shape. To the wound electrode body 30, a positive electrode lead 35 and a negative electrode lead 36 are coupled.

The battery can 41 has a hollow structure with a closed end and an open end, and includes one or more of metal materials including, without limitation, iron, aluminum, and an alloy thereof. The battery can 41 has a surface that may be plated with, for example, nickel. The insulating plates 42 and 43 are disposed in such a manner as to sandwich the wound electrode body 30 therebetween, and extend in a direction intersecting a wound peripheral surface of the wound electrode body 30.

A battery cover 44, a safety valve mechanism 45, and a positive temperature coefficient (PTC) device 46 are crimped at the open end of the battery can 41 by means of a gasket 47 having an insulating property, thereby sealing the open end of the battery can 41. The battery cover 44 includes a material similar to a material included in the battery can 41. The safety valve mechanism 45 and the PTC device 46 are each disposed on an inner side of the battery cover 44. The safety valve mechanism 45 is electrically coupled to the battery cover 44 via the PTC device 46. When an internal pressure of the battery can 41 reaches a certain level or higher as a result of causes including, without limitation, internal short circuiting and heating from outside, a disk plate 45A in the safety valve mechanism 45 inverts, thereby cutting off the electrical coupling between the battery cover 44 and the wound electrode body 30. The PTC device 46 involves an increase in resistance in accordance with a rise in temperature, in order to prevent abnormal heat generation resulting from a large current. The gasket 47 may have a surface on which a material such as asphalt is applied, for example.

The wound electrode body 30 includes a positive electrode 31, a negative electrode 32, a separator 33, and an electrolyte layer 34. The wound electrode body 30 has a structure in which the positive electrode 31 and the negative electrode 32 are stacked on each other with the separator 33 and the electrolyte layer 34 interposed therebetween, and the stack of the positive electrode 31, the negative electrode 32, the separator 33, and the electrolyte layer 34 is wound. The electrolyte layer 34 is interposed between the positive electrode 31 and the separator 33, and between the negative electrode 32 and the separator 33. The positive electrode lead 35 is coupled to the positive electrode 31 (a positive electrode current collector 31A), and the negative electrode lead 36 is coupled to the negative electrode 32 (a negative electrode current collector 32A).

A center pin 37 is disposed in the space provided at the winding center of the wound electrode body 30. It should be understood, however, that the center pin 37 may be omitted. The positive electrode lead 35 includes one or more of electrically conductive materials including, without limitation, aluminum. The positive electrode lead 35 is electrically coupled to the battery cover 44 via the safety valve mechanism 45. The negative electrode lead 36 includes one or more of electrically conductive materials including, without limitation, copper, nickel, and stainless steel (SUS). The negative electrode lead 36 is electrically coupled to the battery can 41. The positive electrode lead 35 and the negative electrode lead 36 each have a shape such as a thin plate shape or a meshed shape.

As illustrated in FIG. 2, the positive electrode 31 includes the positive electrode current collector 31A and a positive electrode active material layer 31B, and the negative electrode 32 includes the negative electrode current collector 32A and a negative electrode active material layer 32B. Configurations of the positive electrode current collector 31A, the positive electrode active material layer 31B, the negative electrode current collector 32A, and the negative electrode active material layer 32B are similar to the configurations of the positive electrode current collector 11A, the positive electrode active material layer 11B, the negative electrode current collector 12A, and the negative electrode active material layer 12B, respectively. That is, the negative electrode 32 (the negative electrode active material layer 32B) includes the hydroxycarboxylic acid compound.

Configurations of the separator 33 and the electrolyte layer 34 are similar to the configurations of the separator 13 and the electrolyte layer 14, respectively. In other words, the electrolytic solution in the electrolyte layer 34 includes the high-dielectric-constant solvent (the lactone), and the content of the lactone in the high-dielectric-constant solvent is within a range from 65 wt % to 100 wt % both inclusive. Further, the electrolyte layer 34 includes the inorganic oxide particles. The inorganic oxide particles each include a material such as zirconium oxide, and have a median diameter D50 of less than or equal to 1 μm.

The secondary battery operates as described below. Upon charging the secondary battery, lithium is extracted from the positive electrode 31, and the extracted lithium is inserted into the negative electrode 32 via the electrolyte layer 34. In contrast, upon discharging the secondary battery, lithium is extracted from the negative electrode 32, and the extracted lithium is inserted into the positive electrode 31 via the electrolyte layer 34.

In a case of manufacturing the secondary battery, the positive electrode 31, the negative electrode 32, and the electrolyte layer 34 are fabricated, following which the secondary battery is assembled, according to a procedure described below.

The positive electrode 31 is fabricated in accordance with a procedure similar to the procedure for fabricating the positive electrode 11, and the negative electrode 32 is fabricated in accordance with a procedure similar to the procedure for fabricating the negative electrode 12. That is, in a case of fabricating the positive electrode 31, the positive electrode active material layer 31B is formed on each of opposite sides of the positive electrode current collector 31A. In a case of fabricating the negative electrode 32, the negative electrode active material layer 32B is formed on each of opposite sides of the negative electrode current collector 32A.

The electrolyte layer 34 is fabricated in accordance with a procedure similar to the procedure for fabricating the electrolyte layer 14. That is, the application solution is applied on a surface of the positive electrode 31 (the positive electrode active material layer 31B) to thereby form the electrolyte layer 34, and the application solution is applied on a surface of the negative electrode 32 (the negative electrode active material layer 32B) to thereby form the electrolyte layer 34.

First, the positive electrode lead 35 is coupled to the positive electrode 31 (the positive electrode current collector 31A) by a method such as a welding method, and the negative electrode lead 36 is coupled to the negative electrode 32 (the negative electrode current collector 32A) by a method such as a welding method. Thereafter, the positive electrode 31 on which the electrolyte layer 34 is formed and the negative electrode 32 on which the electrolyte layer 34 is formed are stacked on each other with the separator 33 interposed therebetween, following which the stack of the positive electrode 31, the negative electrode 32, the separator 33, and the electrolyte layers 34 is wound to thereby fabricate the wound electrode body 30. Thereafter, the center pin 37 is disposed in the space provided at the winding center of the wound electrode body 30. Thereafter, the wound electrode body 30 is interposed between the pair of insulating plates 42 and 43, and the wound electrode body 30 in that state is contained in the battery can 41 together with the insulating plates 42 and 43. In this case, the positive electrode lead 35 is coupled to the safety valve mechanism 45 by a method such as a welding method, and the negative electrode lead 36 is coupled to the battery can 41 by a method such as a welding method. Lastly, the open end of the battery can 41 is crimped by means of the gasket 47 to thereby attach the battery cover 44, the safety valve mechanism 45, and the PTC device 46 to the open end of the battery can 41. Thus, the wound electrode body 30 is sealed in the battery can 41. As a result, the secondary battery of the cylindrical type is completed.

According to the secondary battery of the cylindrical type, configurations of the negative electrode 32 and the electrolyte layer 34 (the electrolytic solution) are similar to the configurations of the negative electrode 12 and the electrolyte layer 14 (the electrolytic solution), respectively. Accordingly, reduction in a discharge capacity is suppressed even if charging and discharging are repeated under a severe environment such as a high-temperature environment for a reason similar to that in the above description of the secondary battery of the laminated-film type. It is thus possible to achieve a superior battery characteristic.

Other action and effects of the secondary battery of the cylindrical type are similar to the other action and effects of the secondary battery of the laminated-film type.

Next, a description is given of modifications of the above-described secondary battery. The configuration of the secondary battery is appropriately modifiable as described below. It should be understood that any two or more of the following series of modifications may be combined.

In FIG. 2, the wound electrode body 10 includes the electrolyte layer 14, and the electrolyte layer 14 includes the inorganic oxide particles. However, a site where the inorganic oxide particles are included, i.e., an inclusion site of the inorganic oxide particles, is not limited to the electrolyte layer 14, and is changeable.

Specifically, instead of the electrolyte layer 14, the positive electrode 11 (the positive electrode active material layer 11B) may include the inorganic oxide particles. In a case of fabricating such a positive electrode 11, the positive electrode active material layer 11B including the inorganic oxide particles is formed by using a positive electrode mixture including the inorganic oxide particles. In this case also, the wound electrode body 10 including such a positive electrode 11 stably exhibits properties including, without limitation, the above-described heat dissipation property of the inorganic oxide particles. Accordingly, it is possible to achieve similar effects.

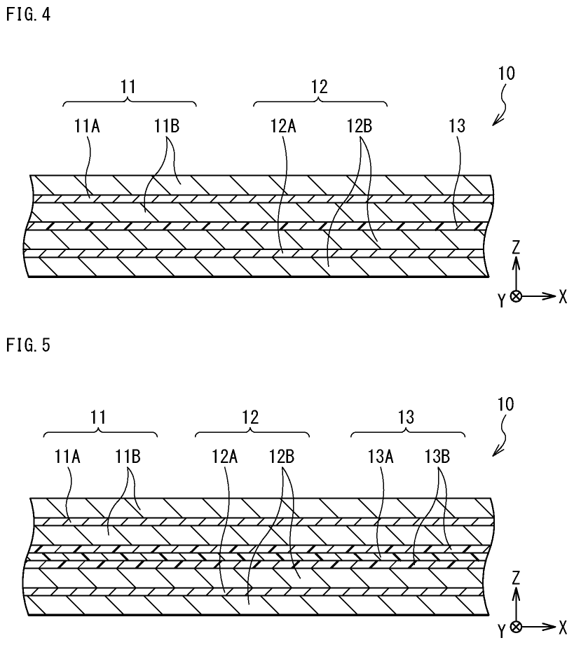

It should be understood that, in the case where the positive electrode 11 includes the inorganic oxide particles, the wound electrode body 10 may include the electrolyte layer 14 as illustrated in FIG. 2, or the wound electrode body 10 may include no electrolyte layer 14 as illustrated in FIG. 4 corresponding to FIG. 2.

In the case where the positive electrode 11 includes the inorganic oxide particles, the wound electrode body 10 illustrated in FIG. 4 has a configuration similar to the configuration of the wound electrode body 10 illustrated in FIG. 2, except for the following differences. First, the inorganic oxide particles are included in the positive electrode active material layer 11B instead of the electrolyte layer 14. Second, no electrolyte layer 14 is interposed between the positive electrode 11 and the separator 13, and no electrolyte layer 14 is interposed between the negative electrode 12 and the separator 13. Third, the positive electrode 11, the negative electrode 12, and the separator 13 are each impregnated with the electrolytic solution.

Alternatively, instead of the electrolyte layer 14, the negative electrode 12 (the negative electrode active material layer 12B) may include the inorganic oxide particles. In a case of fabricating such a negative electrode 12, the negative electrode active material layer 12B including the inorganic oxide particles is formed by using a negative electrode mixture including the inorganic oxide particles. In this case also, the wound electrode body 10 including such a negative electrode 12 stably exhibits properties including, without limitation, the above-described heat dissipation property of the inorganic oxide particles. Accordingly, it is possible to achieve similar effects.

It should be understood that, in the case where the negative electrode 12 includes the inorganic oxide particles, the wound electrode body 10 may include the electrolyte layer 14 as illustrated in FIG. 2, or the wound electrode body 10 may include no electrolyte layer 14 as illustrated in FIG. 4 corresponding to FIG. 2.

In the case where the negative electrode 12 includes the inorganic oxide particles, the wound electrode body 10 illustrated in FIG. 4 has a configuration similar to the configuration of the wound electrode body 10 illustrated in FIG. 2, except for the following differences. First, the inorganic oxide particles are included in the negative electrode active material layer 12B instead of the electrolyte layer 14. Second, no electrolyte layer 14 is interposed between the positive electrode 11 and the separator 13, and no electrolyte layer 14 is interposed between the negative electrode 12 and the separator 13. Third, the positive electrode 11, the negative electrode 12, and the separator 13 are each impregnated with the electrolytic solution.

Alternatively, as illustrated in FIG. 5 corresponding to FIG. 2, the separator 13 (a polymer compound layer 13B), instead of the electrolyte layer 14, may include the inorganic oxide particles.

The separator 13 is a separator of a stacked type including the above-described polymer compound layer 13B. Specifically, the separator 13 includes a porous layer 13A, and the polymer compound layer 13B that is disposed on the porous layer 13A. The polymer compound layer 13B may be provided on each of opposite sides of the porous layer 13A or may be provided only on one of the opposite sides of the porous layer 13A. Here, the polymer compound layer 13B is provided on each of the opposite sides of the porous layer 13A. A reason for this is that adherence of the separator 13 to each of the positive electrode 11 and the negative electrode 12 improves to suppress the occurrence of positional deviation of the wound electrode body 10. This helps to prevent the secondary battery from easily swelling even if, for example, the decomposition reaction of the electrolytic solution occurs.

The porous layer 13A is the above-described porous film and has an insulating property. The polymer compound layer 13B includes one or more of polymer compounds including, without limitation, polyvinylidene difluoride. A reason for this is that such a polymer compound has superior physical strength and is electrochemically stable.

In a case of fabricating the separator 13, the polymer compound and the inorganic oxide particles are mixed with an additional solvent for viscosity adjustment on an as-needed basis to thereby prepare an application solution. In this case, as described above, the inorganic oxide particles each include a material such as zirconium oxide, and are set to have a median diameter D50 of less than or equal to 1 μm. Thereafter, the application solution is applied on the opposite sides of the porous layer 13A to thereby form the polymer compound layers 13B.

In this case also, the wound electrode body 10 including such a separator 13 stably exhibits the above-described heat dissipation property of the inorganic oxide particles. Accordingly, it is possible to achieve similar effects.

It should be understood that, in the case where the separator 13 (the polymer compound layer 13B) includes the inorganic oxide particles, the wound electrode body 10 may include no electrolyte layer 14 as illustrated in FIG. 5. Alternatively, although not specifically illustrated here, in the case where the separator 13 includes the inorganic oxide particles, the wound electrode body 10 may include the electrolyte layer 14.

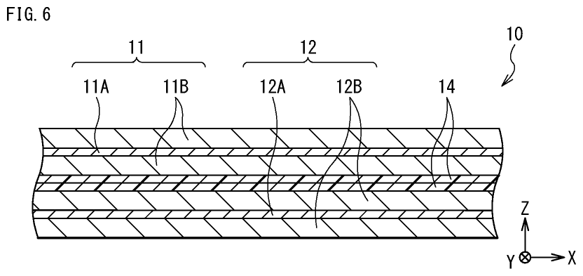

In FIG. 2, the wound electrode body 10 includes the electrolyte layer 14 together with the separator 13. However, if the wound electrode body 10 includes the electrolyte layer 14, the wound electrode body 10 may include no separator 13, that is, the separator 13 may be omitted, as illustrated in FIG. 6 corresponding to FIG. 2. As a result, the electrolyte layer 14 provided on the surface of the positive electrode 11 and the electrolyte layer 14 provided on the surface of the negative electrode 12 are adjacent to each other. The positive electrode 11 and the negative electrode 12 are thus separated from each other with the two electrolyte layers 14 interposed therebetween.

However, any one of the electrolyte layer 14 provided on the surface of the positive electrode 11 or the electrolyte layer 14 provided on the surface of the negative electrode 12 may be omitted. The positive electrode 11 and the negative electrode 12 may thus be separated from each other with one electrolyte layer 14 interposed therebetween.

In this case, the wound electrode body 10 includes no separator 13. The inorganic oxide particles are thus included in one of the positive electrode 11, the negative electrode 12, or the electrolyte layer 14. In this case also, the wound electrode body 10 stably exhibits the above-described heat dissipation property of the inorganic oxide particles. Accordingly, it is possible to achieve similar effects.

Here, the inclusion sites of the inorganic oxide particles are sorted out as described below.

In the case where the wound electrode body 10 includes the separator 13, the inorganic oxide particles are included in one of the positive electrode 11 (the positive electrode active material layer 11B), the negative electrode 12 (the negative electrode active material layer 12B), the separator 13 (the polymer compound layer 13B), or the electrolyte layer 14. It should be understood that the inorganic oxide particles may be included in any two or more of the positive electrode 11, the negative electrode 12, the separator 13, or the electrolyte layer 14.

In the case where the wound electrode body 10 includes no separator 13, the inorganic oxide particles are included in one of the positive electrode 11 (the positive electrode active material layer 11B), the negative electrode 12 (the negative electrode active material layer 12B), or the electrolyte layer 14. It should be understood that the inorganic oxide particles may be included in any two or more of the positive electrode 11, the negative electrode 12, or the electrolyte layer 14.

In any of the above-described cases, the wound electrode body 10 stably exhibits the heat dissipation property of the inorganic oxide particles. Accordingly, it is possible to achieve similar effects.

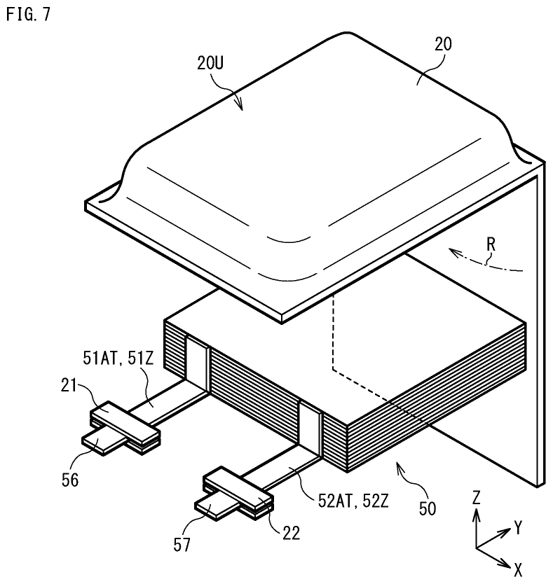

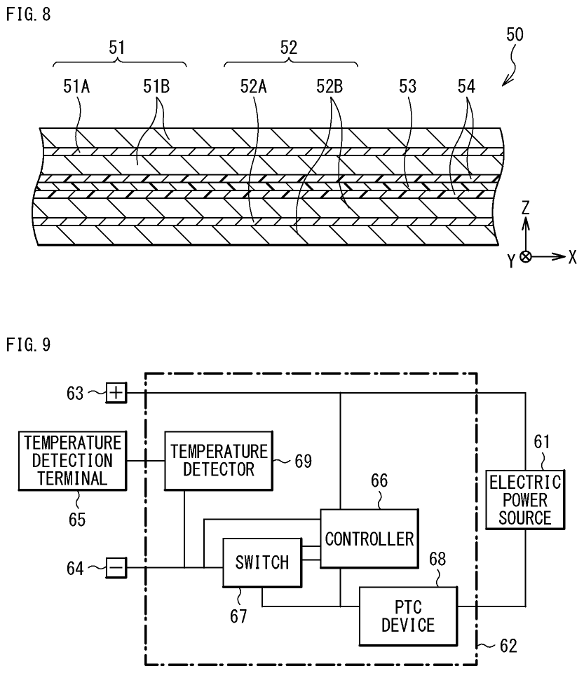

In FIGS. 1 and 2, the battery device of the wound type, i.e., the wound electrode body 10, is used. However, as illustrated in FIGS. 7 and 8 respectively corresponding to FIGS. 1 and 2, a battery device of a stacked type, i.e., a stacked electrode body 50, may be used instead of the wound electrode body 10.

A secondary battery of a laminated-film type illustrated in FIGS. 7 and 8 has a configuration similar to that of the secondary battery of the laminated-film type illustrated in FIGS. 1 and 2, except that the secondary battery of the laminated-film type illustrated in FIGS. 7 and 8 includes the stacked electrode body 50 (a positive electrode 51, a negative electrode 52, a separator 53, and an electrolyte layer 54), a positive electrode lead 56, and a negative electrode lead 57, instead of the wound electrode body 10 (the positive electrode 11, the negative electrode 12, the separator 13, and the electrolyte layer 14), the positive electrode lead 16, and the negative electrode lead 17.

Configurations of the positive electrode 51, the negative electrode 52, the separator 53, the electrolyte layer 54, the positive electrode lead 56, and the negative electrode lead 57 are similar to the configurations of the positive electrode 11, the negative electrode 12, the separator 13, the electrolyte layer 14, the positive electrode lead 16, and the negative electrode lead 17, respectively, except for those described below.

In the stacked electrode body 50, the positive electrode 51 and the negative electrode 52 are alternately stacked on each other with the separator 53 and the electrolyte layer 54 interposed therebetween. The respective numbers of the positive electrode 51, the negative electrode 52, the separator 53, and the electrolyte layer 54 to be stacked are not particularly limited. Here, multiple positive electrodes 51 and multiple negative electrodes 52 are alternately stacked on each other with multiple separators 53 and multiple electrolyte layers 54 interposed therebetween. The positive electrode 51 includes a positive electrode current collector 51A and a positive electrode active material layer 51B, and the negative electrode 52 includes a negative electrode current collector 52A and a negative electrode active material layer 52B.

It should be understood that, as illustrated in FIGS. 7 and 8, the positive electrode current collector 51A includes a projecting part 51AT in which no positive electrode active material layer 51B is provided. The negative electrode current collector 52A includes a projecting part 52AT in which no negative electrode active material layer 52B is provided. The projecting part 52AT is disposed at a position which does not overlap with the projecting part 51AT. Multiple projecting parts 51AT are joined to each other to thereby form a single joint part 51Z having a lead shape. Multiple projecting parts 52AT are joined to each other to thereby form a single joint part 52Z having a lead shape. The positive electrode lead 56 is coupled to the joint part 51Z, and the negative electrode lead 57 is coupled to the joint part 52Z.

A method of manufacturing the secondary battery of the laminated-film type illustrated in FIGS. 7 and 8 is similar to the method of manufacturing the secondary battery of the laminated-film type illustrated in FIGS. 1 and 2, except that the stacked electrode body 50 (the positive electrode lead 56 and the negative electrode lead 57) is fabricated instead of the wound electrode body 10 (the positive electrode lead 16 and the negative electrode lead 17).

In a case of fabricating the stacked electrode body 50, first, the positive electrode 51 is fabricated in which the positive electrode active material layer 51B is provided on each of opposite sides of the positive electrode current collector 51A (excluding the projecting part 51AT), and the negative electrode 52 is fabricated in which the negative electrode active material layer 52B is provided on each of opposite sides of the negative electrode current collector 52A (excluding the projecting part 52AT). Thereafter, the electrolyte layer 54 is formed on a surface of the positive electrode 51 (the positive electrode active material layer 51B), and the electrolyte layer 54 is formed on a surface of the negative electrode 52 (the negative electrode active material layer 52B). Thereafter, the multiple positive electrodes 51 and the multiple negative electrodes 52 are alternately stacked on each other with the multiple separators 53 and the multiple electrolyte layers 54 interposed therebetween, to thereby fabricate the stacked electrode body 50. Thereafter, the multiple projecting parts 51AT are joined to each other by a method such as a welding method to thereby form the joint part 51Z, and the multiple projecting parts 52AT are joined to each other by a method such as a welding method to thereby form the joint part 52Z. Thereafter, the positive electrode lead 56 is coupled to the projecting part 51AT by a method such as a welding method, and the negative electrode lead 57 is coupled to the projecting part 52AT by a method such as a welding method.

In the case where the stacked electrode body 50 is used also, it is possible to achieve effects similar to those in the case where the wound electrode body 10 is used.

The secondary battery of the laminated-film type illustrated in FIGS. 1 and 2 is not particularly limited in the number of the positive electrode leads 16 and the number of the negative electrode leads 17. In other words, the number of the positive electrode leads 16 is not limited to one, and may be two or more, and the number of the negative electrode leads 17 is not limited to one, and may be two or more. Similar effects are also achievable in the case where the number of the positive electrode leads 16 and the number of the negative electrode leads 17 are changed.

Here, the descriptions are given of the respective cases where Modifications 1 to 7 are applied to the secondary battery of the laminated-film type. However, Modifications 1 to 7 may be applied to the secondary battery of the cylindrical type instead of the secondary battery of the laminated-film type. In such cases also, it is possible to achieve similar effects.

Next, a description is given of applications (application examples) of the above-described secondary battery.

The applications of the secondary battery are not particularly limited as long as they are, for example, machines, equipment, instruments, apparatuses, or systems (an assembly of a plurality of pieces of equipment, for example) in which the secondary battery is usable mainly as a driving power source, an electric power storage source for electric power accumulation, or any other source. The secondary battery used as a power source may serve as a main power source or an auxiliary power source. The main power source is preferentially used regardless of the presence of any other power source. The auxiliary power source may be used in place of the main power source, or may be switched from the main power source on an as-needed basis. In a case where the secondary battery is used as the auxiliary power source, the kind of the main power source is not limited to the secondary battery.

Specific examples of the applications of the secondary battery include: electronic equipment including portable electronic equipment; portable life appliances; apparatuses for data storage; electric power tools; battery packs to be mounted as detachable power sources on, for example, laptop personal computers; medical electronic equipment; electric vehicles; and electric power storage systems. Examples of the electronic equipment include video cameras, digital still cameras, mobile phones, laptop personal computers, cordless phones, headphone stereos, portable radios, portable televisions, and portable information terminals. Examples of the portable life appliances include electric shavers. Examples of the apparatuses for data storage include backup power sources and memory cards. Examples of the electric power tools include electric drills and electric saws. Examples of the medical electronic equipment include pacemakers and hearing aids. Examples of the electric vehicles include electric automobiles including hybrid automobiles. Examples of the electric power storage systems include home battery systems for accumulation of electric power for a situation such as emergency. It should be understood that the secondary battery may have a battery structure of the above-described laminated-film type, the above-described cylindrical type, or any other type. Further, multiple secondary batteries may be used, for example, as a battery pack or a battery module.

In particular, the battery pack and the battery module are each effectively applied to relatively large-sized equipment, etc., including an electric vehicle, an electric power storage system, and an electric power tool. The battery pack, as will be described later, may include a single battery, or may include an assembled battery. The electric vehicle is a vehicle that operates (travels) using the secondary battery as a driving power source, and may be an automobile that is additionally provided with a driving source other than the secondary battery as described above, such as a hybrid automobile. The electric power storage system is a system that uses the secondary battery as an electric power storage source. An electric power storage system for home use accumulates electric power in the secondary battery which is an electric power storage source, and the accumulated electric power may thus be utilized for using, for example, home appliances.

Some application examples of the secondary battery will now be described in detail. The configurations of the application examples described below are merely examples, and are appropriately modifiable. The secondary battery to be used in the following application examples is not limited to a particular kind, and may therefore be of a laminated-film type or a cylindrical type.

FIG. 9 illustrates a block configuration of a battery pack including a single battery. The battery pack described here is a simple battery pack (a so-called soft pack) including one secondary battery, and is to be mounted on, for example, electronic equipment typified by a smartphone.

As illustrated in FIG. 9, the battery pack includes an electric power source 61 and a circuit board 62. The circuit board 62 is coupled to the electric power source 61, and includes a positive electrode terminal 63, a negative electrode terminal 64, and a temperature detection terminal (a so-called T terminal) 65.

The electric power source 61 includes one secondary battery. The secondary battery has a positive electrode lead coupled to the positive electrode terminal 63 and a negative electrode lead coupled to the negative electrode terminal 64. The electric power source 61 is couplable to outside via the positive electrode terminal 63 and the negative electrode terminal 64, and is thus chargeable and dischargeable via the positive electrode terminal 63 and the negative electrode terminal 64. The circuit board 62 includes a controller 66, a switch 67, a PTC device 68, and a temperature detector 69. However, the PTC device 68 may be omitted.

The controller 66 includes, for example, a central processing unit (CPU) and a memory, and controls an overall operation of the battery pack. The controller 66 detects and controls a use state of the electric power source 61 on an as-needed basis.

If a battery voltage of the electric power source 61 (the secondary battery) reaches an overcharge detection voltage or an overdischarge detection voltage, the controller 66 turns off the switch 67. This prevents a charging current from flowing into a current path of the electric power source 61. In addition, if a large current flows upon charging or discharging, the controller 66 turns off the switch 67 to block the charging current. The overcharge detection voltage and the overdischarge detection voltage are not particularly limited. For example, the overcharge detection voltage is 4.2 V±0.05 V and the overdischarge detection voltage is 2.4 V±0.1 V.

The switch 67 includes, for example, a charge control switch, a discharge control switch, a charging diode, and a discharging diode. The switch 67 performs switching between coupling and decoupling between the electric power source 61 and external equipment in accordance with an instruction from the controller 66. The switch 67 includes, for example, a metal-oxide-semiconductor field-effect transistor (MOSFET) including a metal-oxide semiconductor. The charging and discharging currents are detected on the basis of an ON-resistance of the switch 67.

The temperature detector 69 includes a temperature detection device such as a thermistor. The temperature detector 69 measures a temperature of the electric power source 61 using the temperature detection terminal 65, and outputs a result of the temperature measurement to the controller 66. The result of the temperature measurement to be obtained by the temperature detector 69 is used, for example, in a case where the controller 66 performs charge/discharge control upon abnormal heat generation or in a case where the controller 66 performs a correction process upon calculating a remaining capacity.

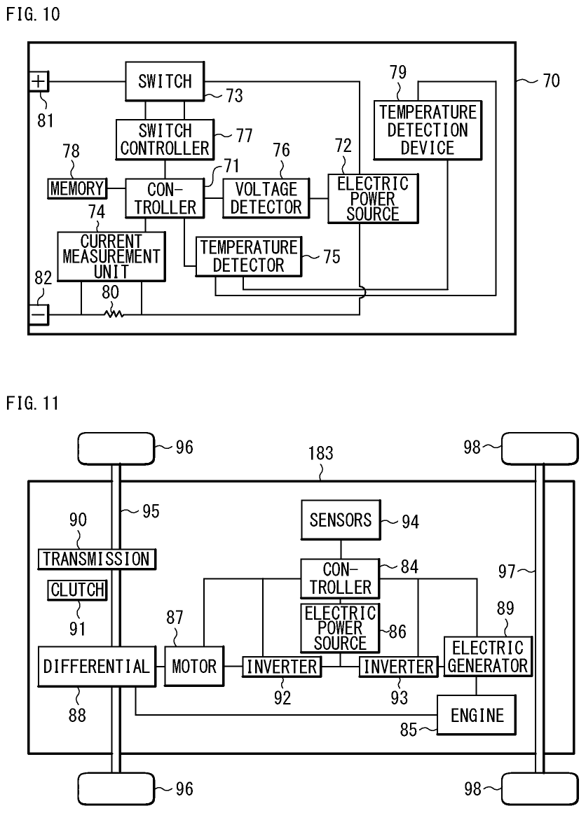

FIG. 10 illustrates a block configuration of a battery pack including an assembled battery. In the following description, reference will be made as necessary to the components of the battery pack including the single battery (FIG. 9).

As illustrated in FIG. 10, the battery pack includes a positive electrode terminal 81 and a negative electrode terminal 82. Specifically, the battery pack includes, inside a housing 70, the following components: a controller 71, an electric power source 72, a switch 73, a current measurement unit 74, a temperature detector 75, a voltage detector 76, a switch controller 77, a memory 78, a temperature detection device 79, and a current detection resistor 80.

The electric power source 72 includes an assembled battery in which two or more secondary batteries are coupled to each other, and a type of the coupling of the two or more secondary batteries is not particularly limited. Accordingly, the coupling scheme may be in series, in parallel, or of a mixed type of both. For example, the electric power source 72 includes six secondary batteries coupled to each other in two parallel and three series.

Configurations of the controller 71, the switch 73, the temperature detector 75, and the temperature detection device 79 are similar to those of the controller 66, the switch 67, and the temperature detector 69 (the temperature detection device). The current measurement unit 74 measures a current using the current detection resistor 80, and outputs a result of the measurement of the current to the controller 71. The voltage detector 76 measures a battery voltage of the electric power source 72 (the secondary battery) and provides the controller 71 with a result of the measurement of the voltage that has been subjected to analog-to-digital conversion.

The switch controller 77 controls an operation of the switch 73 in response to signals supplied by the current measurement unit 74 and the voltage detector 76. If a battery voltage reaches an overcharge detection voltage or an overdischarge detection voltage, the switch controller 77 turns off the switch 73 (the charge control switch). This prevents a charging current from flowing into a current path of the electric power source 72. This enables the electric power source 72 to perform only discharging via the discharging diode, or only charging via the charging diode. In addition, if a large current flows upon charging or discharging, the switch controller 77 blocks the charging current or the discharging current.

The switch controller 77 may be omitted and the controller 71 may thus also serve as the switch controller 77. The overcharge detection voltage and the overdischarge detection voltage are not particularly limited, and are similar to those described above in relation to the battery pack including the single battery.

The memory 78 includes, for example, an electrically erasable programmable read-only memory (EEPROM) which is a non-volatile memory, and the memory 78 stores, for example, a numeric value calculated by the controller 71 and data (e.g., an initial internal resistance, a full charge capacity, and a remaining capacity) of the secondary battery measured in the manufacturing process.

The positive electrode terminal 81 and the negative electrode terminal 82 are terminals coupled to, for example, external equipment that operates using the battery pack, such as a laptop personal computer, or external equipment that is used to charge the battery pack, such as a charger. The electric power source 72 (the secondary battery) is chargeable and dischargeable via the positive electrode terminal 81 and the negative electrode terminal 82.

FIG. 11 illustrates a block configuration of a hybrid automobile which is an example of the electric vehicle. As illustrated in FIG. 11, the electric vehicle includes, inside a housing 83, the following components: a controller 84, an engine 85, an electric power source 86, a motor 87, a differential 88, an electric generator 89, a transmission 90, a clutch 91, inverters 92 and 93, and sensors 94. The electric vehicle also includes a front wheel drive shaft 95, a pair of front wheels 96, a rear wheel drive shaft 97, and a pair of rear wheels 98. The front wheel drive shaft 95 and the pair of front wheels 96 are coupled to the differential 88 and the transmission 90.

The electric vehicle is configured to travel by using one of the engine 85 or the motor 87 as a driving source. The engine 85 is a major power source, such as a gasoline engine. In a case where the engine 85 is used as a power source, a driving force (a rotational force) of the engine 85 is transmitted to the front wheels 96 and the rear wheels 98 via the differential 88, the transmission 90, and the clutch 91, which are driving parts. It should be understood that the rotational force of the engine 85 is transmitted to the electric generator 89, and the electric generator 89 thus generates alternating-current power by utilizing the rotational force. In addition, the alternating-current power is converted into direct-current power via the inverter 93, and the direct-current power is thus accumulated in the electric power source 86. In contrast, in a case where the motor 87 which is a converter is used as a power source, electric power (direct-current power) supplied from the electric power source 86 is converted into alternating-current power via the inverter 92. Thus, the motor 87 is driven by utilizing the alternating-current power. A driving force (a rotational force) converted from the electric power by the motor 87 is transmitted to the front wheels 96 and the rear wheels 98 via the differential 88, the transmission 90, and the clutch 91, which are the driving parts.

When the electric vehicle is decelerated by means of a brake mechanism, a resistance force at the time of the deceleration is transmitted as a rotational force to the motor 87. Thus, the motor 87 may generate alternating-current power by utilizing the rotational force. The alternating-current power is converted into direct-current power via the inverter 92, and direct-current regenerative power is thus accumulated in the electric power source 86.

The controller 84 includes, for example, a CPU, and controls an overall operation of the electric vehicle. The electric power source 86 includes one or more secondary batteries and is coupled to an external electric power source. In this case, the electric power source 86 may be supplied with electric power from the external electric power source and thereby accumulate the electric power. The sensors 94 are used to control the number of revolutions of the engine 85 and to control an angle of a throttle valve (a throttle angle). The sensors 94 include one or more of sensors including, without limitation, a speed sensor, an acceleration sensor, and an engine speed sensor.

The case where the electric vehicle is a hybrid automobile has been described as an example; however, the electric vehicle may be a vehicle that operates using only the electric power source 86 and the motor 87 and not using the engine 85, such as an electric automobile.

Although not specifically illustrated here, other application examples are also conceivable as application examples of the secondary battery.

Specifically, the secondary battery is applicable to an electric power storage system. The electric power storage system includes, inside a building such as a residential house or a commercial building, the following components: a controller, an electric power source including one or more secondary batteries, a smart meter, and a power hub.

The electric power source is coupled to electric equipment such as a refrigerator installed inside the building, and is couplable to an electric vehicle such as a hybrid automobile stopped outside the building. Further, the electric power source is coupled, via the power hub, to a home power generator such as a solar power generator installed at the building, and is also coupled, via the smart meter and the power hub, to a centralized power system of an external power station such as a thermal power station.

Alternatively, the secondary battery is applicable to an electric power tool such as an electric drill or an electric saw. The electric power tool includes, inside a housing to which a movable part such as a drilling part or a saw blade part is attached, the following components: a controller, and an electric power source including one or more secondary batteries.

### EXAMPLES

A description is given of Examples of the technology below.

### Experiment Examples 1-1 to 1-38

Secondary batteries (lithium-ion secondary batteries) of the laminated-film type illustrated in FIGS. 1, 2, and 6 were fabricated, following which the secondary batteries were evaluated for their respective battery characteristics as described below.

The secondary batteries were fabricated in accordance with the following procedure.

First, 91 parts by mass of the positive electrode active material (LiCoO₂), 3 parts by mass of the positive electrode binder (polyvinylidene difluoride), and 6 parts by mass of the positive electrode conductor (graphite) were mixed with each other to thereby obtain a positive electrode mixture. Thereafter, the positive electrode mixture was put into an organic solvent (N-methyl-2-pyrrolidone), following which the organic solvent was stirred to thereby prepare a paste positive electrode mixture slurry. Thereafter, the positive electrode mixture slurry was applied on opposite sides of the positive electrode current collector 11A (a band-shaped aluminum foil having a thickness of 12 μm) by means of a coating apparatus, following which the applied positive electrode mixture slurry was dried to thereby form the positive electrode active material layers 11B. Lastly, the positive electrode active material layers 11B were compression-molded by means of a roll pressing machine. In this manner, the positive electrode active material layers 11B were formed on respective opposite sides of the positive electrode current collector 11A. Thus, the positive electrode 11 was fabricated.

It should be understood that, in the case of fabricating the positive electrode 11, the inorganic oxide particles were added to the positive electrode mixture on an as-needed basis to thereby form the positive electrode active material layer 11B including the inorganic oxide particles. A kind and the median diameter D50 in micrometer of the inorganic oxide particles were as presented in Table 2. In this case, a content of the inorganic oxide particles in the positive electrode mixture was set to 1 part by mass. It should be understood that adjustment was performed in such a manner that a mixture ratio between the positive electrode active material, the positive electrode binder, and the positive electrode conductor did not change. A column of “inclusion site” presented in each of Tables 1 to 3 indicates a component in which the inorganic oxide particles were included.

First, 93 parts by mass of the negative electrode active material (artificial graphite) and 7 parts by mass of the negative electrode binder (polyvinylidene difluoride) were mixed with each other to obtain a mixture, following which the hydroxycarboxylic acid compound was added to the mixture, to thereby obtain a negative electrode mixture. A type and a kind of the hydroxycarboxylic acid compound were as presented in each of Tables 1 to 3. It should be understood that a column of “type” presented in each of Tables 1 to 3 indicates a type to which the hydroxycarboxylic acid compound belonged. That is, “first” indicates that the hydroxycarboxylic acid compound was the first hydroxycarboxylic acid compound, and “second” indicates that the hydroxycarboxylic acid compound was the second hydroxycarboxylic acid compound. Thereafter, the negative electrode mixture was put into an organic solvent (N-methyl-2-pyrrolidone), following which the organic solvent was stirred to thereby prepare a paste negative electrode mixture slurry. Thereafter, the negative electrode mixture slurry was applied on opposite sides of the negative electrode current collector 12A (a band-shaped copper foil having a thickness of 15 μm) by means of a coating apparatus, following which the applied negative electrode mixture slurry was dried to thereby form the negative electrode active material layers 12B. Lastly, the negative electrode active material layers 12B were compression-molded by means of a roll pressing machine. In this manner, the negative electrode active material layers 12B were formed on the respective opposite sides of the negative electrode current collector 12A. Thus, the negative electrode 12 was fabricated.

It should be understood that, in the case of fabricating the negative electrode 12, the inorganic oxide particles were added to the negative electrode mixture on an as-needed basis to thereby form the negative electrode active material layer 12B including the inorganic oxide particles. The kind and the median diameter D50 in micrometer of the inorganic oxide particles were as presented in Table 2. In this case, the content of the inorganic oxide particles in the negative electrode mixture was set to 1 part by mass. It should be understood that adjustment was performed in such a manner that a mixture ratio between the negative electrode active material and the negative electrode binder did not change.

In a case where the separator 13 included no inorganic oxide particles, the separator 13 of the single-layer type (a porous polyethylene film having a thickness of 5 μm) was prepared.

In a case where the separator 13 included the inorganic oxide particles, the separator 13 of the stacked type was fabricated. In this case, first, the porous layer 13A (a porous polyethylene film having a thickness of 3 μm) was prepared. Thereafter, the polymer compound (polyvinylidene difluoride), the inorganic oxide particles, the additional solvent (diethyl carbonate) for viscosity adjustment were mixed with each other to obtain a mixture, following which the mixture was stirred to thereby prepare the application solution. The kind and the median diameter D50 in micrometer of the inorganic oxide particles were as presented in Table 2. In this case, a mixture ratio (a weight ratio) of the polymer compound to the inorganic oxide particles was set to 3:2. Lastly, the application solution was applied on the opposite sides of the porous layer 13A, following which the applied application solution was dried to thereby form the polymer compound layers 13B including the inorganic oxide particles. In this manner, the polymer compound layers 13B were provided on the respective opposite sides of the porous layer 13A. Thus, the separator 13 of the stacked type was fabricated. It should be understood that a column of “structure” presented in each of Tables 1 to 3 indicates a structure of the separator 13. That is, “single” indicates that the separator 13 was the single-layer type, and “stacked” indicates that the separator 13 was the stacked type.

Where appropriate, no separator 13 was used. A column of “present/absent” presented in each of Tables 1 to 3 indicates presence or absence of the use of the separator 13. That is, “present” indicates that the separator 13 was used, and “absent” indicates that no separator 13 was used.

The electrolyte salt (lithium hexafluorophosphate) was added to a solvent, following which the solvent was stirred to thereby obtain the electrolytic solution. Used as the solvent were: a lactone (γ-butyrolactone (GBL) having a specific dielectric constant (25° C.) of 39) and a cyclic carbonic acid ester (ethylene carbonate having a specific dielectric constant (40° C.) of 90) which served as the high-dielectric-constant solvent; and 4-fluoro-1,3-dioxolane-2-one, which served as the additive (the halogenated carbonic acid ester). The content (wt %) of the lactone in the high-dielectric-constant solvent were as presented in Tables 1 to 3. In a case where the content of the lactone was 100 wt %, only the lactone was used as the high-dielectric-constant solvent, and in a case where the content of the lactone was less than 100 wt %, the cyclic carbonic acid ester was used together with the lactone as the high-dielectric-constant solvent. The content of the halogenated carbonic acid ester in the solvent was set to 5 wt %. The content of the electrolyte salt with respect to the solvent was set to 1 mol/kg.

The electrolytic solution, the polymer compound (polyvinylidene difluoride), and the additional solvent (diethyl carbonate) for viscosity adjustment were mixed with each other to obtain a mixture, following which the mixture was stirred to thereby prepare the application solution. In this case, a mixture ratio (weight ratio) of the electrolytic solution to the polymer compound was set to 15:1. Thereafter, the application solution was applied on the surface of the positive electrode 11, following which the applied application solution was dried to thereby fabricate the electrolyte layer 14, and the application solution was applied on the surface of the negative electrode 12, following which the applied application solution was dried to thereby fabricate the electrolyte layer 14.

It should be understood that, in the case of fabricating the electrolyte layer 14, the inorganic oxide particles were added to the application solution on an as-needed basis to thereby form the electrolyte layer 14 including the inorganic oxide particles. The kind and the median diameter D50 in micrometer of the inorganic oxide particles were as presented in Tables 1 to 3. In this case, a mixture ratio (a weight ratio) between the electrolytic solution, the polymer compound, and the inorganic oxide particles was set to 45:3:2. Further, another kind of inorganic oxide particles (α-type aluminum oxide (α-Al₂O₃)) was also used in combination on an as-needed basis.

For comparison, the electrolyte layer 14 was fabricated in accordance with a similar procedure except that no inorganic oxide particles were used. For comparison, the electrolyte layer 14 was fabricated in accordance with a similar procedure except that other kinds of inorganic oxide particles (α-type aluminum oxide and β-type aluminum oxide (β-Al₂O₃)) were used.

In a case where the electrolyte layer 14 included the inorganic oxide particles, first, the positive electrode lead 16 including aluminum was welded to the positive electrode current collector 11A, and the negative electrode lead 17 including copper was welded to the negative electrode current collector 12A. Thereafter, the positive electrode 11 on which the electrolyte layer 14 including the inorganic oxide particles was formed and the negative electrode 12 on which the electrolyte layer 14 including the inorganic oxide particles was formed were stacked on each other with the separator 13 of the single-layer type interposed therebetween, following which the stack of the positive electrode 11, the negative electrode 12, the separator 13 of the single-layer type, and the electrolyte layers 14 was wound to thereby fabricate the wound electrode body 10. Thereafter, the film 20 was folded in such a manner as to sandwich the wound electrode body 10, following which the outer edges of three sides of the film 20 were thermal fusion bonded to each other. As the film 20, an aluminum laminated film was used in which a fusion-bonding layer (a polypropylene film having a thickness of 30 μm), a metal layer (an aluminum foil having a thickness of 40 μm), and a surface protective layer (a nylon film having a thickness of 25 μm) were stacked in this order from the inner side. In this case, the sealing film 21 (a polypropylene film having a thickness of 5 μm) was interposed between the film 20 and the positive electrode lead 16, and the sealing film 22 (a polypropylene film having a thickness of 5 μm) was interposed between the film 20 and the negative electrode lead 17. In this manner, the wound electrode body 10 was sealed in the film 20. As a result, the secondary battery of the laminated-film type was completed.

In the case where the positive electrode 11 included the inorganic oxide particles, the secondary battery of the laminated-film type was assembled in accordance with a similar procedure except that the positive electrode 11 including the inorganic oxide particles was used and the electrolyte layer 14 including no inorganic oxide particles was used.

In the case where the negative electrode 12 included the inorganic oxide particles, the secondary battery of the laminated-film type was assembled in accordance with a similar procedure except that the negative electrode 12 including the inorganic oxide particles was used and the electrolyte layer 14 including no inorganic oxide particles was used.

In the case where the separator 13 included the inorganic oxide particles, the secondary battery of the laminated-film type was assembled in accordance with a similar procedure except as described below. In the case of fabricating the wound electrode body 10, the positive electrode 11 on which the electrolyte layer 14 including no inorganic oxide particles was formed and the negative electrode 12 on which the electrolyte layer 14 including no inorganic oxide particles was formed were stacked on each other with the separator 13 of the stacked type including the inorganic oxide particles interposed therebetween, following which the stack of the positive electrode 11, the negative electrode 12, the separator 13 of the stacked type, and the electrolyte layers 14 was wound.

In the case where no separator 13 was used, the secondary battery of the laminated-film type was assembled in accordance with a similar procedure except as described below. In the case of fabricating the wound electrode body 10, the positive electrode 11 on which the electrolyte layer 14 including the inorganic oxide particles was formed and the negative electrode 12 on which the electrolyte layer 14 including the inorganic oxide particles was formed were stacked on each other, following which the stack of the positive electrode 11, the negative electrode 12, and the electrolyte layers 14 was wound.

Evaluation of the secondary batteries for their battery characteristic (a cyclability characteristic) revealed the results described in Tables 1 to 3.

In a case of examining the cyclability characteristic, first, the secondary battery was charged and discharged for one cycle in an ambient temperature environment (at a temperature of 23° C.), in order to stabilize a state of the secondary battery. Thereafter, the secondary battery was charged and discharged again in the same environment to thereby measure a second-cycle discharge capacity. Thereafter, the secondary battery was repeatedly charged and discharged in a high-temperature environment (at a temperature of 50° C.) until the number of charging and discharging cycles reached 400 to thereby measure a 400th-cycle discharge capacity. Lastly, the following was calculated: capacity retention rate (%)=(400th-cycle discharge capacity/second-cycle discharge capacity)×100.

Upon charging, the secondary battery was charged with a constant current of 0.5 C until a voltage reached 4.50 V, and was thereafter charged with a constant voltage of 4.50 V until a current reached 0.05 C. Upon discharging, the secondary battery was discharged with a constant current of 0.5 C until the voltage reached 2.5 V. It should be understood that 0.5 C is a value of a current that causes a battery capacity (a theoretical capacity) to be completely discharged in 2 hours, and 0.05 C is a value of a current that causes the battery capacity to be completely discharged in 20 hours.

TABLE 1

| | High-dielectric-constant | | | | | | | | | | |
|---|---|---|---|---|---|---|---|---|---|---|---|
| | solvent (lactone) | | | | | | | | | | |
| | | Specific | | Inorganic oxide | | | | | | | Capacity |
| | | dielectric | | particles | | | Hydroxycarboxylic | | Separator | | retention |
| Experiment | | constant | Content | | D50 | Inclusion | acid compound | | Present/ | | rate |
| example | Kind | (25° C.) | (wt %) | Kind | (μm) | site | Type | Kind | Absent | Structure | (%) |
| 1-1 | GBL | 39 | 65 | ZrO₂ | 0.5 | Electrolyte | Second | Formula | Present | Single | 72 |
| 1-2 | | | 75 | | | layer | | (2-8) | | | 77 |
| 1-3 | | | 85 | | | | | | | | 78 |
| 1-4 | | | 95 | | | | | | | | 77 |
| 1-5 | | | 100 | | | | | | | | 78 |
| 1-6 | GBL | 39 | 75 | ZrO₂ | 0.5 | Electrolyte | First | Formula | Present | Single | 74 |
| | | | | | | layer | | (1-1) | | | |
| 1-7 | | | | | | | First | Formula | | | 77 |
| | | | | | | | | (1-2) | | | |
| 1-8 | | | | | | | First | Formula | | | 73 |
| | | | | | | | | (1-3) | | | |
| 1-9 | | | | | | | First | Formula | | | 76 |
| | | | | | | | | (1-7) | | | |
| 1-10 | | | | | | | First | Formula | | | 73 |
| | | | | | | | | (1-8) | | | |
| 1-11 | | | | | | | First | Formula | | | 77 |
| | | | | | | | | (1-9) | | | |
| 1-12 | GBL | 39 | 75 | σ- | 0.05 | Electrolyte | Second | Formula | Present | Single | 75 |
| | | | | Al₂O₃ | | layer | | (2-8) | | | |
| 1-13 | | | | κ- | | | | | | | 76 |
| | | | | Al₂O₃ | | | | | | | |
| 1-14 | | | | Θ- | | | | | | | 79 |
| | | | | Al₂O₃ | | | | | | | |
| 1-15 | | | | χ- | | | | | | | 76 |
| | | | | Al₂O₃ | | | | | | | |
| 1-16 | | | | ρ- | | | | | | | 75 |
| | | | | Al₂O₃ | | | | | | | |

TABLE 2

| | High-dielectric-constant | | | | | | | | | | |
|---|---|---|---|---|---|---|---|---|---|---|---|
| | solvent (lactone) | | | | | | | | | | |
| | | Specific | | Inorganic oxide | | | | | | | Capacity |
| | | dielectric | | particles | | | Hydroxycarboxylic | | Separator | | retention |
| Experiment | | constant | Content | | D50 | Inclusion | acid compound | | Present/ | | rate |
| example | Kind | (25° C.) | (wt %) | Kind | (μm) | site | Type | Kind | Absent | Structure | (%) |
| 1-17 | GBL | 39 | 75 | η- | 0.05 | Electrolyte | Second | Formula | Present | Single | 76 |
| | | | | Al₂O₃ | | layer | | (2-8) | | | |
| 1-18 | | | | γ- | | | | | | | 79 |
| | | | | Al₂O₃ | | | | | | | |
| 1-19 | | | | ZrO₂ + | 0.5 + | | | | | | 78 |
| | | | | α- | 0.05 | | | | | | |
| | | | | Al₂O₃ | | | | | | | |
| 1-20 | GBL | 39 | 75 | ZrO₂ | 0.05 | Electrolyte | Second | Formula | Present | Single | 79 |
| 1-21 | | | | | 1.0 | layer | | (2-8) | | | 75 |
| 1-22 | GBL | 39 | 75 | ZrO₂ | 0.5 | Positive | Second | Formula | Present | Single | 78 |
| | | | | | | electrode | | (2-8) | | | |
| 1-23 | GBL | 39 | 75 | ZrO₂ | 0.5 | Negative | Second | Formula | Present | Single | 77 |
| | | | | | | electrode | | (2-8) | | | |
| 1-24 | GBL | 39 | 65 | ZrO₂ | 0.5 | Separator | Second | Formula | Present | Stacked | 71 |
| 1-25 | | | 75 | | | | | (2-8) | | | 78 |
| 1-26 | | | 85 | | | | | | | | 77 |
| 1-27 | | | 95 | | | | | | | | 79 |
| 1-28 | | | 100 | | | | | | | | 78 |
| 1-29 | GBL | 39 | 75 | ZrO₂ | 0.5 | Electrolyte | Second | Formula | Absent | — | 76 |
| | | | | | | layer | | (2-8) | | | |

TABLE 3

| | High-dielectric-constant | | | | | | | | | | |
|---|---|---|---|---|---|---|---|---|---|---|---|
| | solvent (lactone) | | | | | | | | | | |
| | | Specific | | Inorganic oxide | | | | | | | Capacity |
| | | dielectric | | particles | | | Hydroxycarboxylic | | Separator | | retention |
| Experiment | | constant | Content | | D50 | Inclusion | acid compound | | Present/ | | rate |
| example | Kind | (25° C.) | (wt %) | Kind | (μm) | site | Type | Kind | Absent | Structure | (%) |
| 1-30 | GBL | 39 | 15 | ZrO₂ | 0.5 | Electrolyte | Second | Formula | Present | Single | 65 |
| 1-31 | | | 30 | | | layer | | (2-8) | | | 64 |
| 1-32 | | | 45 | | | | | | | | 63 |
| 1-33 | | | 60 | | | | | | | | 66 |
| 1-34 | GBL | 39 | 75 | ZrO₂ | 0.5 | Electrolyte | — | — | Present | Single | 49 |
| | | | | | | layer | | | | | |
| 1-35 | GBL | 39 | 75 | — | — | — | Second | Formula | Present | Single | 48 |
| | | | | | | | | (2-8) | | | |
| 1-36 | | | | α- | 0.05 | Electrolyte | Second | Formula | Present | Single | 50 |
| | | | | Al₂O₃ | | layer | | (2-8) | | | |
| 1-37 | | | | θ- | | | | | | | 51 |
| | | | | Al₂O₃ | | | | | | | |
| 1-38 | GBL | 39 | 75 | ZrO₂ | 2.0 | Electrolyte | Second | Formula | Present | Single | 65 |
| | | | | | | layer | | (2-8) | | | |

As described in Tables 1 to 3, the battery characteristic (the cyclability characteristic) of the secondary battery varied greatly depending on the configuration of the secondary battery.

Specifically, the capacity retention rate greatly increased in a case where the following three conditions were satisfied simultaneously (Experiment examples 1-1 to 1-29) as compared with a case where the three conditions were not satisfied simultaneously (Experiment examples 1-30 to 1-38).

Condition 1

The negative electrode 12 (the negative electrode active material layer 12B) included the hydroxycarboxylic acid compound.

Condition 2

The electrolytic solution (the high-dielectric-constant solvent) in the electrolyte layer 14 included the lactone (GBL) and the content of the lactone in the high-dielectric-constant solvent was within a range from 65 wt % to 100 wt % both inclusive.

Condition 3

The electrolyte layer 14 included the inorganic oxide particles each including a material such as zirconium oxide, and the inorganic oxide particles had a median diameter D50 of less than or equal to 1 μm.

Specifically, focusing on Condition 1 (the presence or absence of the hydroxycarboxylic acid compound), in a case where the negative electrode 12 included one of the first hydroxycarboxylic acid compound or the second hydroxycarboxylic acid compound (Experiment examples 1-2 and 1-6 to 1-11), the capacity retention rate greatly increased as compared with a case where the negative electrode 12 included neither the first hydroxycarboxylic acid compound nor the second hydroxycarboxylic acid compound (Experiment example 1-34).

Focusing on Condition 2 (the content of the lactone), in a case where the content of the lactone in the high-dielectric-constant solvent was within a range from 65 wt % to 100 wt % both inclusive (Experiment examples 1-1 to 1-5), the capacity retention rate greatly increased as compared with a case where the content of the lactone in the high-dielectric-constant solvent was less than 65 wt % (Experiment examples 1-30 to 1-33).

Focusing on Condition 3 (the kind and the median diameter of the inorganic oxide particles), in a case where the inorganic oxide particles each included a material such as zirconium oxide having an appropriate particle size (i.e., median diameter D50) (Experiment examples 1-2 and 1-12 to 1-19), the capacity retention rate greatly increased as compared with a case where the inorganic oxide particles were not used (Experiment example 1-35) and a case where the inorganic oxide particles included no material such as zirconium oxide having the appropriate particle size (Experiment examples 1-36 and 1-37).

It should be understood that, if the inorganic oxide particles each included zirconium oxide having the appropriate particle size, a sufficient capacity retention rate was obtained even if the inorganic oxide particles further included α-type aluminum oxide (Experiment example 1-19).

In addition, regarding Condition 3, even if, instead of the electrolyte layer 14, each of the positive electrode 11, the negative electrode 12, and the separator 13 included the inorganic oxide particles (Experiment examples 1-22 to 1-28), a sufficient capacity retention rate was obtained in a similar manner as a case where the electrolyte layer 14 included the inorganic oxide particles (Experiment examples 1-1 to 1-5).

Further, even if the wound electrode body 10 included no separator 13 (Experiment example 1-29), a sufficient capacity retention rate was obtained in a similar manner as a case where the wound electrode body 10 included the separator 13 (Experiment example 1-2).

### Experiment Examples 2-1 to 2-4

As described in Table 4, secondary batteries were fabricated and were evaluated for their battery characteristic (the cyclability characteristic) by similar procedures except that the composition of the electrolytic solution included in the electrolyte layer 14 was changed. In this case, the content of the halogenated carbonic acid ester (FEC) in the electrolytic solution was changed. Further, 1,3-dioxol-2-one (VC) serving as the unsaturated cyclic carbonic acid ester was used instead of the halogenated carbonic acid ester, and the content of the unsaturated cyclic carbonic acid ester in the electrolytic solution was varied. Moreover, the electrolytic solution was prepared without using the halogenated carbonic acid ester and the unsaturated cyclic carbonic acid ester.

TABLE 4

| | Unsaturated | | | | |
|---|---|---|---|---|---|
| | cyclic | | Halogenated | | |
| | carbonic acid | | carbonic acid | | Capacity |
| | ester | | ester | | retention |
| Experiment | | Content | | Content | rate |
| example | Kind | (wt %) | Kind | (wt %) | (%) |
| 2-1 | — | — | — | — | 69 |
| 2-2 | VC | 1 | — | — | 74 |
| 2-3 | | 5 | | | 76 |
| 2-4 | — | — | FEC | 1 | 75 |
| 1-2 | | | | 5 | 77 |

As described in Table 4, in a case where the electrolytic solution included one of the unsaturated cyclic carbonic acid ester or the halogenated carbonic acid ester (Experiment examples 1-2 and 2-2 to 2-4), the capacity retention rate increased as compared with a case where the electrolytic solution included neither the unsaturated cyclic carbonic acid ester nor the halogenated carbonic acid ester (Experiment example 2-1).

### Experiment Examples 3-1 to 3-10, 4-1 to 4-8, and 5-1 to 5-18

As described in Tables 5 to 7, secondary batteries were fabricated and were evaluated for their battery characteristic (the cyclability characteristic) by similar procedures except that the composition of the electrolytic solution included in the electrolyte layer 14 was changed. In this case, a sulfonic acid ester, a sulfuric acid ester, a sulfurous acid ester, a disulfonic acid anhydride, a dicarboxylic acid anhydride, a sulfonic acid carboxylic acid anhydride, and a nitrile compound were newly used as the additive. Respective contents (wt %) of the sulfonic acid ester, the sulfuric acid ester, the sulfurous acid ester, the disulfonic acid anhydride, the dicarboxylic acid anhydride, the sulfonic acid carboxylic acid anhydride, and the nitrile compound were as presented in Tables 5 to 7.

Used as the sulfonic acid ester were 1,2-oxathiolane-2,2-dioxide (PS), 5H-1,2-oxathiol-2,2-dioxide (PES), 1,2-oxathiane-2,2-dioxide (BS1), 3-methyl-1,2-oxathiolane-2,2-dioxide (BS2), and methanesulfonic acid propargyl ester (MSPE).

Used as the sulfuric acid ester were 1,3,2-dioxathiolane-2,2-dioxide (DODO1), 1,3,2-dioxathion-2,2-dioxide (DODO2), and 4-methylsulfonyloxymethyl-2,2-dioxo-1,3,2-dioxathiolane (MSOD).

Used as the sulfurous acid ester were 1,3,2-dioxathiolane-2-oxide (DOO) and 4-methyl-1,3,2-dioxathiolane-2-oxide (MDOO).

Used as the disulfonic acid anhydride were 1,2-ethanedisulfonic acid anhydride (EDS), 1,3-propanedisulfonic acid anhydride (PDS), and hexafluoro-1,3-propanedisulfonic acid anhydride (HFPS).

Used as the dicarboxylic acid anhydride were 1,4-dioxane-2,6-dione (DODON), succinic acid anhydride (SA), and glutaric acid anhydride (GA).

Used as the sulfonic acid carboxylic acid anhydride were 2-sulfobenzoic acid anhydride (SBA) and 2,2-dioxooxathiolane-5-one (DOON).

Used as the nitrile compound were octanenitrile (ON), benzonitrile (BN), phthalonitrile (FN), succinonitrile (SN), glutaronitrile (GN), adiponitrile (AN), cebaconitrile (SBN), 1,3,6-hexanetricarbonitrile (HTCN), 3,3′-oxydipropionitrile (ODPN), 3-butoxypropionitrile (BPN), ethylene glycol bispropionitrile ether (EGPNE), 1,2,2,3-tetracyanopropane (TCP), tetracyanoethylene (TCE), fumaronitrile (FMN), 7,7,8,8-tetracy anoquinodimethane (TCQM), cyclopentanecarbonitrile (CPCN), 1,3,5-cyclohexanetricarbonitrile (CHTCN), and 1,3-bis(dicyanomethylidene)indane (BDCMI).

TABLE 5

| | Sulfonic acid | | Sulfuric acid | | Sulfurous acid | | Capacity |
|---|---|---|---|---|---|---|---|
| | ester | | ester | | ester | | retention |
| Experiment | | Content | | Content | | Content | rate |
| example | Kind | (wt %) | Kind | (wt %) | Kind | (wt %) | (%) |
| 1-2 | — | — | — | — | — | — | 77 |
| 3-1 | PS | 1 | — | — | — | — | 82 |
| 3-2 | PES | 1 | — | — | — | — | 85 |
| 3-3 | BS1 | 1 | — | — | — | — | 83 |
| 3-4 | BS2 | 1 | — | — | — | — | 87 |
| 3-5 | MSPE | 1 | — | — | — | — | 84 |
| 3-6 | — | — | DODO1 | 1 | — | — | 81 |
| 3-7 | — | — | DODO2 | 1 | — | — | 83 |
| 3-8 | — | — | MSOD | 1 | — | — | 85 |
| 3-9 | — | — | — | — | DOO | 1 | 86 |
| 3-10 | — | — | — | — | MDOO | 1 | 80 |

TABLE 6

| | | | | | Sulfonic acid | | |
|---|---|---|---|---|---|---|---|
| | Disulfonic acid | | Dicarboxylic acid | | carboxylic acid | | Capacity |
| | anhydride | | anhydride | | anhydride | | retention |
| Experiment | | Content | | Content | | Content | rate |
| example | Kind | (wt %) | Kind | (wt %) | Kind | (wt %) | (%) |
| 1-2 | — | — | — | — | — | — | 77 |
| 4-1 | EDS | 1 | — | — | — | — | 85 |
| 4-2 | PDS | 1 | — | — | — | — | 86 |
| 4-3 | HFPS | 1 | — | — | — | — | 87 |
| 4-4 | — | — | DODON | 1 | — | — | 83 |
| 4-5 | — | — | SA | 1 | — | — | 86 |
| 4-6 | — | — | GA | 1 | — | — | 87 |
| 4-7 | — | — | — | — | SBA | 1 | 80 |
| 4-8 | — | — | — | — | DOON | 1 | 82 |

TABLE 7

| | Nitrile | | Capacity |
|---|---|---|---|
| | compound | | retention |
| Experiment | | Content | rate |
| example | Kind | (wt %) | (%) |
| 1-2 | — | — | 77 |
| 5-1 | ON | 0.5 | 79 |
| 5-2 | BN | 0.5 | 80 |
| 5-3 | FN | 0.5 | 79 |
| 5-4 | SN | 0.5 | 81 |
| 5-5 | GN | 0.5 | 82 |
| 5-6 | AN | 0.5 | 78 |
| 5-7 | SBN | 0.5 | 80 |
| 5-8 | HTCN | 0.5 | 81 |
| 5-9 | ODPN | 0.5 | 82 |
| 5-10 | BPN | 0.5 | 79 |
| 5-11 | EGPNE | 0.5 | 78 |
| 5-12 | TCP | 0.5 | 82 |
| 5-13 | TCE | 0.5 | 81 |
| 5-14 | FMN | 0.5 | 83 |
| 5-15 | TCQM | 0.5 | 78 |
| 5-16 | CPCN | 0.5 | 80 |
| 5-17 | CHTCN | 0.5 | 81 |
| 5-18 | BDCMI | 0.5 | 82 |

As described in Table 5, in a case where the electrolytic solution included one of the sulfonic acid ester, the sulfuric acid ester, or the sulfurous acid ester (Experiment examples 3-1 to 3-10), the capacity retention rate increased as compared with a case where the electrolytic solution included none of the sulfonic acid ester, the sulfuric acid ester, or the sulfurous acid ester (Experiment example 1-2).

As described in Table 6, in a case where the electrolytic solution included one of the disulfonic acid anhydride, the dicarboxylic acid anhydride, or the sulfonic acid carboxylic acid anhydride (Experiment examples 4-1 to 4-8), the capacity retention rate increased as compared with a case where the electrolytic solution included none of the disulfonic acid anhydride, the dicarboxylic acid anhydride, or the sulfonic acid carboxylic acid anhydride (Experiment example 1-2).

As described in Table 7, in a case where the electrolytic solution included the nitrile compound (Experiment examples 5-1 to 5-18), the capacity retention rate increased as compared with a case where the electrolytic solution included no nitrile compound (Experiment example 1-2).

Based upon the results described in Tables 1 to 7, in the case where the negative electrode included the hydroxycarboxylic acid compound, where the electrolytic solution included the high-dielectric-constant solvent (the lactone) and the content of the lactone in the high-dielectric-constant solvent was within a range from 65 wt % to 100 wt % both inclusive, and where the inorganic oxide particles each included a material such as zirconium oxide and had a median diameter D50 of less than or equal to 1 μm, the cyclability characteristic improved. Accordingly, a superior battery characteristic of the secondary battery was obtained.

Although the technology has been described above with reference to the embodiments and Examples, configurations of the technology are not limited to those described with reference to the embodiments and Examples above and are modifiable in a variety of ways.

Specifically, although the description has been given of the case of using the liquid electrolyte (the electrolytic solution) and the case of using the gel electrolyte (the electrolyte layer), the electrolyte is not particularly limited in kind. Thus, an electrolyte in a solid form (a solid electrolyte) may be used.

Further, although the description has been given of the case where the secondary battery has a battery structure of the laminated-film type or the cylindrical type, the battery structure is not particularly limited. Accordingly, the battery structure of the secondary battery may be of any other type, such as a prismatic type or a coin type.

Further, although the description has been given of the case where the battery device has a device structure of the wound type and the case where the battery device has a device structure of the stacked type, the device structure of the battery device is not particularly limited. Accordingly, the device structure of the battery device may be of any other type, such as a zigzag folded type in which the electrodes (the positive electrode and the negative electrode) are each folded in a zigzag manner.

Further, although the description has been given of the case where the electrode reactant is lithium, the electrode reactant is not particularly limited. Specifically, the electrode reactant may be another alkali metal such as sodium or potassium, or may be an alkaline earth metal such as beryllium, magnesium, or calcium, as described above. In addition, the electrode reactant may be another light metal such as aluminum.

The effects described herein are mere examples, and effects of the technology are therefore not limited to those described herein. Accordingly, the present technology may achieve any other effect.

It should be understood that various changes and modifications to the presently preferred embodiments described herein will be apparent to those skilled in the art. Such changes and modifications can be made without departing from the spirit and scope of the present subject matter and without diminishing its intended advantages. It is therefore intended that such changes and modifications be covered by the appended claims.

1. A secondary battery comprising:
a positive electrode;
a negative electrode including a hydroxycarboxylic acid compound, the hydroxycarboxylic acid compound including a first hydroxycarboxylic acid compound represented by Formula (1), a second hydroxycarboxylic acid compound represented by Formula (2), or both; and
an electrolyte including a high-dielectric-constant solvent having a dielectric constant of greater than or equal to 20 in a temperature range of higher than or equal to −30 degrees Celsius and lower than 60 degrees Celsius, the high-dielectric-constant solvent including a lactone, a content of the lactone in the high-dielectric-constant solvent being greater than or equal to 65 weight percent and less than or equal to 100 weight percent, wherein
at least one of the positive electrode, the negative electrode, or the electrolyte includes inorganic oxide particles, and
the inorganic oxide particles each include at least one of zirconium oxide, σ-type aluminum oxide, κ-type aluminum oxide, θ-type aluminum oxide, χ-type aluminum oxide, ρ-type aluminum oxide, η-type aluminum oxide, or γ-type aluminum oxide, and have a median diameter D50 of less than or equal to 1 micrometer, 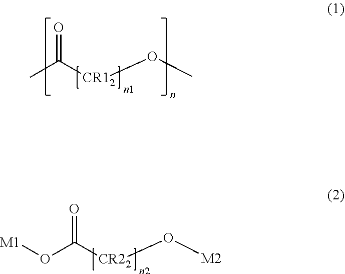
wherein
each of R1 and R2 represents one of a hydrogen group, a halogen group, an alkyl group, or a halogenated alkyl group,
each of M1 and M2 represents one of hydrogen or an alkali metal element,
n is an integer of greater than or equal to 2, and
each of n1 and n2 is 2, 3, or 4.

2. The secondary battery according to claim 1, wherein
the halogen group includes at least one of a fluorine group, a chlorine group, a bromine group, or an iodine group, and
the halogenated alkyl group includes at least one of the fluorine group, the chlorine group, the bromine group, or the iodine group.

3. The secondary battery according to claim 1, wherein the alkyl group and the halogenated alkyl group each have carbon number of greater than or equal to 1 and less than or equal to 5.

4. The secondary battery according to claim 2, wherein the alkyl group and the halogenated alkyl group each have carbon number of greater than or equal to 1 and less than or equal to 5.

5. The secondary battery according to claim 1, wherein the alkali metal element comprises one of lithium (Li), sodium (Na), or potassium (K).

6. The secondary battery according to claim 1, wherein the lactone includes at least one of γ-butyrolactone, β-propiolactone, γ-crotonolactone, 4-hydroxy-2-methyl-2-butenoic acid γ-lactone, α-methyl-γ-butyrolactone, α-angelicalactone, 1,4-dioxane-2-one, 3-methyl-2(5H)-furanone, γ-valerolactone, or δ-valerolactone.

7. The secondary battery according to claim 1, wherein
the electrolyte comprises an electrolyte layer, the electrolyte layer including an electrolytic solution and a polymer compound, the polymer compound holding the electrolytic solution,
the electrolytic solution includes a solvent and an electrolyte salt, the solvent including the high-dielectric-constant solvent, and
the electrolyte layer includes the inorganic oxide particles.

8. The secondary battery according to claim 1, wherein the positive electrode includes the inorganic oxide particles.

9. The secondary battery according to claim 1, wherein the negative electrode includes the inorganic oxide particles.

10. The secondary battery according to claim 1, further comprising a separator interposed between the positive electrode and the negative electrode.

11. The secondary battery according to claim 1, wherein the electrolyte further includes an unsaturated cyclic carbonic acid ester, a halogenated carbonic acid ester, or both.

12. The secondary battery according to claim 1, wherein the electrolyte further includes at least one of a sulfonic acid ester, a sulfuric acid ester, a sulfurous acid ester, a disulfonic acid anhydride, a dicarboxylic acid anhydride, or a sulfonic acid carboxylic acid anhydride.

13. The secondary battery according to claim 1, wherein the electrolyte further includes a nitrile compound.

14. The secondary battery according to claim 1, wherein the secondary battery comprises a lithium-ion secondary battery.

15. A secondary battery comprising:
a positive electrode;
a negative electrode including a hydroxycarboxylic acid compound, the hydroxycarboxylic acid compound including a first hydroxycarboxylic acid compound represented by Formula (1), a second hydroxycarboxylic acid compound represented by Formula (2), or both;
a separator interposed between the positive electrode and the negative electrode; and
an electrolyte including a high-dielectric-constant solvent having a dielectric constant of greater than or equal to 20 in a temperature range of higher than or equal to −30 degrees Celsius and lower than 60 degrees Celsius, the high-dielectric-constant solvent including a lactone, a content of the lactone in the high-dielectric-constant solvent being greater than or equal to 65 weight percent and less than or equal to 100 weight percent, wherein
the separator includes inorganic oxide particles, and
the inorganic oxide particles each include at least one of zirconium oxide, σ-type aluminum oxide, κ-type aluminum oxide, θ-type aluminum oxide, χ-type aluminum oxide, ρ-type aluminum oxide, η-type aluminum oxide, or γ-type aluminum oxide, and have a median diameter D50 of less than or equal to 1 micrometer, 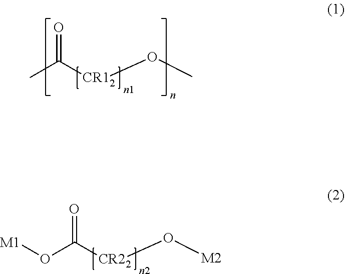
wherein
each of R1 and R2 represents one of a hydrogen group, a halogen group, an alkyl group, or a halogenated alkyl group,
each of M1 and M2 represents one of hydrogen or an alkali metal element,
n is an integer of greater than or equal to 2, and
each of n1 and n2 is 2, 3, or 4.

16. The secondary battery according to claim 15, wherein
the separator includes a porous layer and a polymer compound layer, the porous layer having an insulating property, the polymer compound layer being disposed on the porous layer, and
the polymer compound layer includes the inorganic oxide particles.

17. The secondary battery according to claim 15, wherein at least one of the positive electrode, the negative electrode, or the electrolyte includes the inorganic oxide particles.

18. The secondary battery according to claim 16, wherein at least one of the positive electrode, the negative electrode, or the electrolyte includes the inorganic oxide particles.
